(19) United States
(12) Patent Application Publication
(10) Pub. No.: US 2026/0337308 A1
(43) Pub. Date: Oct. 29, 2026

(54) Methods for Preparing Diphenylsilane Bridged C1 Symmetric Catalysts and Polymers Made Therefrom

(71) Applicant: ExxonMobil Chemical Patents Inc., Battown, TX (US)

(72) Inventors: Nikola S. Lambic, Seabrook, TX (US); Gregory J. Smith-Karahalis, Houston, TX (US); An N.M. Nguyen, Pearland, TX (US)

(21) Appl. No.: 18/997,129

(22) PCT Filed: Jul. 31, 2023
(86) PCT No.: PCT/US2023/071323

§ 371 Date: Jan. 20, 2025

Related U.S. Application Data
(60) Provisional application No. 63/370,829, filed on Aug. 9, 2022.

(51) Int. Cl. C08F 10/06; C07F 17/00

(52) U.S. Cl. CPC C08F 10/06; C07F 17/00; C08F 2420/09

(57) ABSTRACT

Di-aryl silane bridged metallocene catalysts, methods for making and propylene (co)polymers made therefrom. The resulting silane bridged metallocene catalysts are very active in polymerization of olefins, especially ethylene and propylene. The di-aryl silane bridged metallocene can be synthesized by substituting a dichloro cyclopentadienyl fragment with indenyl lithium. Direct lithitation/substitution with aryl or alkyl lithium reagents provides a di-lithiated ligand that undergoes metalation with a Group IV metal precursor.

### CROSS REFERENCE TO RELATED APPLICATIONS

This application claims the benefit of and priority to U.S. Provisional Application No. 63/370,829 filed Aug. 9, 2022, the disclosure of which is incorporated herein by reference.

### BACKGROUND OF THE INVENTION

### Field of the Invention

Embodiments of the present invention generally relate to asymmetric metallocene catalyst compounds. More particularly, embodiments of the present invention relate to asymmetric, bridged metallocenes with substituted indacenyl ligands and propylene polymers made therefrom.

### Description of the Related Art

Synthesis of traditional bridged metallocenes relies on the substitution of a leaving group X with an incoming lithium salt of an indene, indacene, or cyclopentadiene. In recent years, silane bridged metallocenes have been discovered that can efficiently produce propylene polymers with desirable physical and mechanical properties.

Diphenylsilane bridged metallocenes, in particular, have been investigated. Diphenylsilane bridged metallocenes, however, remain rather elusive synthetic targets due to the difficulty associated with their preparation. Challenges with installing diphenylsilane bridges have been associated with increased proton acidity of the critical CpHSi(Ph)₂X (X=Cl, OTf) intermediate, where addition of a second nucleophile (such as indenyl lithium or fluorenyl lithium) yields a mixture of products. This addition of the second nucleophile also favors Cp deprotonation, rather than the intended nucleophilic substitution of the Si—X group. This deprotonation substantially complicates the synthesis and requires many, tedious purification steps.

References of interest include: CN101235106B, which details synthesis of 1-indenyl analogs of diphenylsilane; U.S. Pat. No. 9,790,240 B2 describes a mixed C₂ symmetric system of diphenylsilane derivatives; Izmer, V. et al. (2001) “ansa-Metallocenes with a Ph₂Si Bridge: Molecular Structures of HfCl₂[Ph₂Si(η⁵—C₅H₄)] and HfCl₂[Ph₂Si(C₁₃H₉)(η⁵—C₅H₄)]₂,” J. Chem. Soc., Dalton Trans., pp. 1131-1136; WO2001/005870A1 and WO2002/002575A1 describe C₂ symmetric complexes with arylsilane bridges; Heuer, B. et al. (2005) “Alternating Ethene/Propene Copolymers by C₁-Symmetric Metallocene/MAO Catalysts,” Macromolecules, v.38(8), pp. 3054-3059; EP 0754698A2; EP 1046642A2, which describes Cp-fluorenyl analogs with diphenylsilane bridge; US 2019/0161559A1 and WO2018/151904A1 describe bis-Cp analogs with a diphenylsilane bridge; US 2020/043758, WO2014/099303, U.S. Pat. No. 9,266,910B2; and KR 2020003044.

There is still a need for a new and more reliable method for synthesizing diphenylsilane bridged metallocenes for making propylene polymers.

### SUMMARY OF THE INVENTION

Di-aryl silane bridged metallocene catalysts, methods for making and propylene (co)polymers made therefrom are provided herein. The resulting silane bridged metallocene catalysts are very active in polymerization of olefins, especially ethylene and surprisingly propylene. In at least one embodiment, a catalyst system comprising a metallocene compound described in the Formula (I) is provided:

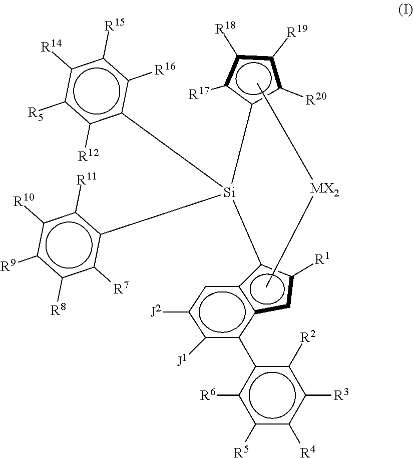

where M is a Group 4 metal; each of X1 and X2 is a univalent anionic ligand, or X1 and X2 are joined to form a metallocycle ring; R¹ is hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, where R″ is C₁-C₁₀ alkyl and each R′ is hydrogen, halogen, C₁-C₁₀ alkyl, or C₆-C₁₀ aryl.

J¹ and J² are independently hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, where R″ is C₁-C₁₀ alkyl and each R′ is hydrogen, halogen, C₁-C₁₀ alkyl, or C₆-C₁₀ aryl. Optionally J¹ and J² can be joined to form a 4, 5 or 6 membered ring.

Each R²-R⁶ can be hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, where R″ is C₁-C₁₀ alkyl and each R′ is hydrogen, halogen, C₁-C₁₀ alkyl, or C₆-C₁₀ aryl.

Each R⁷-R¹⁶ can be hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, where R″ is C₁-C₁₀ alkyl and each R′ is hydrogen, halogen, C₁-C₁₀ alkyl, or C₆-C₁₀ aryl; optionally, R¹¹ and R¹² can be joined to form a silafluorene moiety.

Each R¹⁷, R¹⁸, R¹⁹, and R²⁰ can be independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, wherein R″ is C₁-C₁₀ alkyl and each R′ is hydrogen, halogen, C₁-C₁₀ alkyl, or C₆-C₁₀ aryl.

### BRIEF DESCRIPTION OF THE DRAWINGS

So that the manner in which the above recited features of the present invention can be understood in detail, a more particular description of the invention, briefly summarized above, can be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows the ¹H NMR spectrum of di-lithium salt prepared in a single step (“one pot”), according to one or more embodiments described herein.

FIG. 2 shows the ¹H NMR spectrum of Catalyst 12 made in the experimental section below.

### DETAILED DESCRIPTION

According to one or more embodiments provided herein, a di-aryl silane bridged metallocene can be synthesized by substituting a dichloro cyclopentadienyl fragment with indenyl lithium. In the next step, direct lithitation/substitution with aryl or alkyl lithium reagents provides a di-lithiated ligand that undergoes metalation with a Group IV metal precursor.

It has been surprisingly and unexpectedly discovered that a significant diversification of silane groups of ansa metallocenes can be made. It was also surprisingly and unexpectedly discovered that diphenyl silane bridged metallocenes could be synthesized using fewer steps than conventional synthesis. It was even more surprising and unexpected that homopropylenes and ethylene-propylene copolymers could be made from the silane bridged metallocenes having improved molecular weight capabilities, while maintaining excellent catalyst activity and polymer melting point temperature.

The general synthesis method provided herein avoids and eliminates the electronic effects that promote deprotonation instead of nucleophilic substitution of the prior art. The general synthesis methods described herein also allow for significant diversification of aryl silane derivatives, and in particular di-aryl silane derivatives. The general synthesis for making the catalysts can also be applied towards mixed asymmetric di-aryl, or mono-aryl derivatives. The resulting silane bridged metallocene catalysts are very active in polymerization of olefins, especially ethylene and surprisingly propylene.

A conventional preparation of silyl bridged metallocenes required 4 steps, as illustrated below:

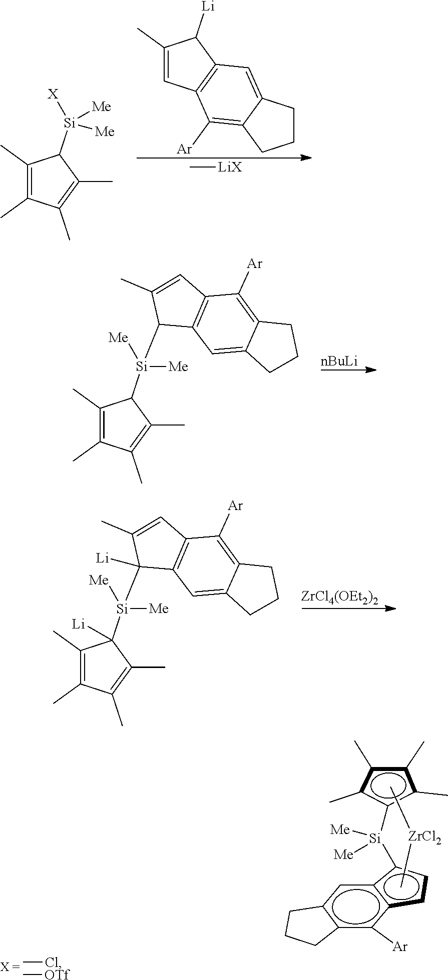

It was previously known that the reactivity of a diphenylsilane analog favors deprotonation rather than substitution, as shown below:

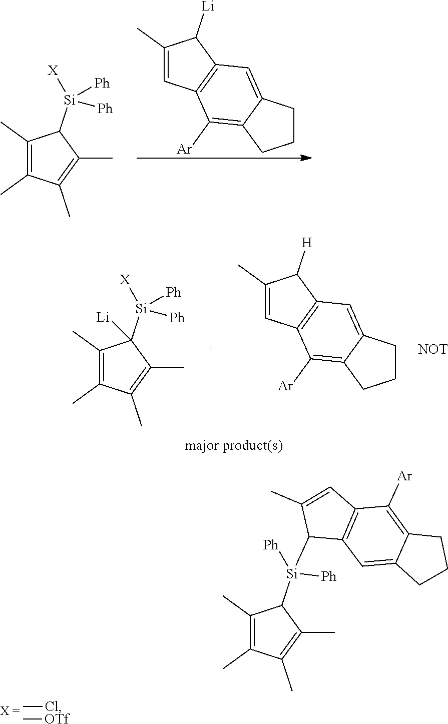

It has now been surprisingly and unexpectedly discovered that diphenyl silane bridged metallocenes can be synthesized in just 3 steps. To do so, a dichloro cyclopentadienyl fragment first undergoes substitution with indenyl lithium. Next, direct lithitation/substitution with aryl or alkyl lithium reagents provides a di-lithiated ligand that undergoes transmetallation with at least one Group (IV) metal salt to provide a metallocene precursor containing a di-aryl bridge, as shown below:

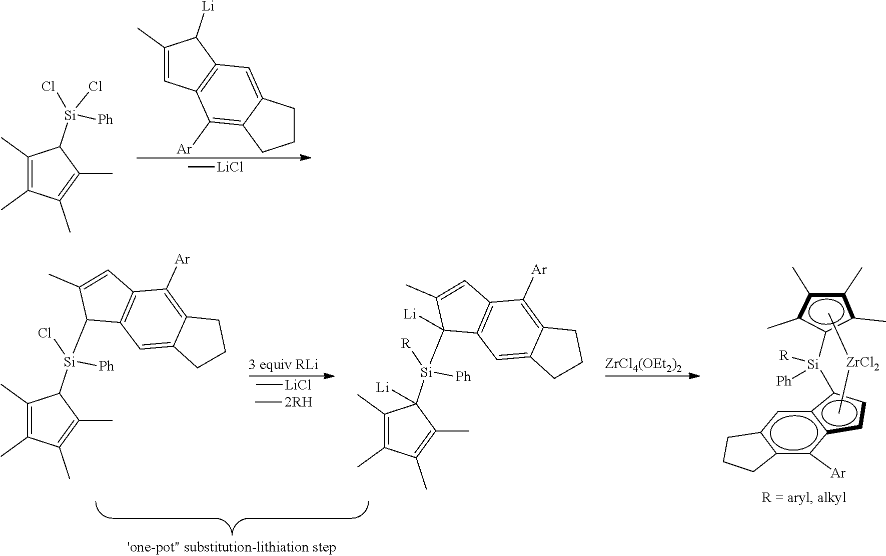

Such new metallocene compounds and new synthesis techniques as well as the polymers produced therefrom will now be described in more detail below. Each of the appended claims defines a separate invention, which for infringement purposes is recognized as including equivalents to the various elements or limitations specified in the claims. Depending on the context, all references below to the “invention” may in some cases refer to certain specific embodiments only. In other cases, it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this disclosure is combined with publicly available information and technology.

The diphenylsilane bridge metallocenes provided herein can be supported or unsupported, and can be represented by the Formula (I):

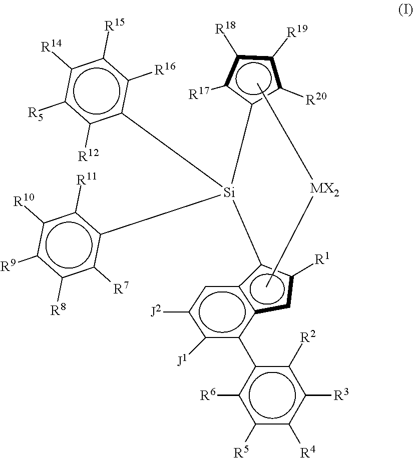

where:
M is a Group 4 metal.

Each of X1 and X2 can be a univalent anionic ligand, or X1 and X2 can be joined to form a metallocycle ring.

R¹ can be hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, where R″ is C₁-C₁₀ alkyl and each R′ is hydrogen, halogen, C₁-C₁₀ alkyl, or C₆-C₁₀ aryl.

Each J¹ and J² can be hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′2, —SR′, —OR, —SiR′³, —OSiR′³, —PR′², or —R″—SiR′³, where R″ is C₁-C₁₀ alkyl and each R′ is hydrogen, halogen, C₁-C₁₀ alkyl, or C₆-C₁₀ aryl. Optionally J¹ and J² can be joined to form a 4, 5 or 6 membered ring.

Each R²-R⁶ can be hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, where R″ is C₁-C₁₀ alkyl and each R′ is hydrogen, halogen, C₁-C₁₀ alkyl, or C₆-C₁₀ aryl.

Each R⁷-R¹⁶ can be hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, where R″ is C₁-C₁₀ alkyl and each R′ is hydrogen, halogen, C₁-C₁₀ alkyl, or C₆-C₁₀ aryl. Optionally, R¹¹ and R¹² can be joined.

Each R¹⁷, R¹⁸, R¹⁹, and R²⁰ can be independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, wherein R″ is C₁-C₁₀ alkyl and each R′ is hydrogen, halogen, C₁-C₁a alkyl, or C₆-C₁₀ aryl.

For nomenclature purposes, the following numbering schemes are used for indenyl. It should be noted that indenyl can be considered a cyclopentadienyl fused with a benzene ring. The structure below is drawn and named as an anion.

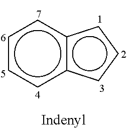

Also for clarity, the following ring structures are substituted indenyls, where the substitution at the 5 and 6 positions forms a ring structure. For specific compound nomenclature purposes, these ligands are described below. A similar numbering and nomenclature scheme is used for these types of substituted indenyls that include indacenyls, cyclopenta[b]naphthalenyls, heterocyclopentanaphthyls, heterocyclopentaindenyls, and the like, as illustrated below. Each structure is drawn and named as an anion.

Non-limiting examples of indacenyls and cyclopenta[b]naphthalenyls include:

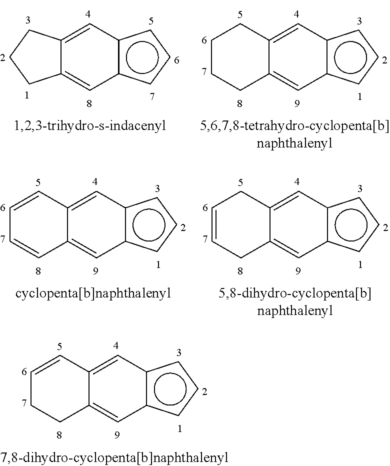

The synthetic route provided herein allows for significant diversification of C₁ symmetric catalysts by the virtue of a bridge modification. For example, complexes such as the ones below are now accessible using the synthetic route provided herein.

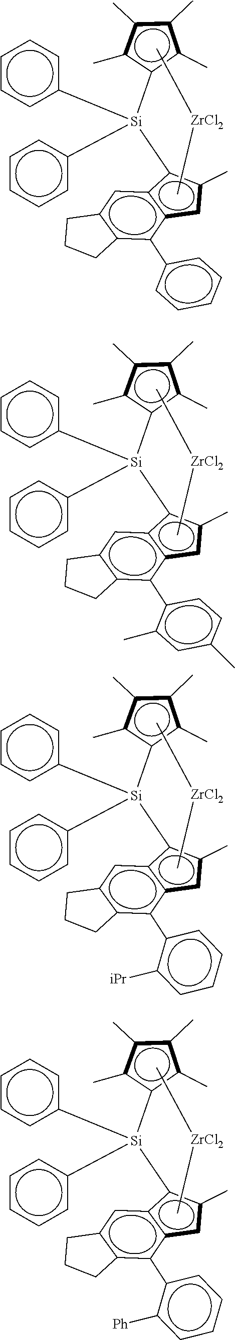

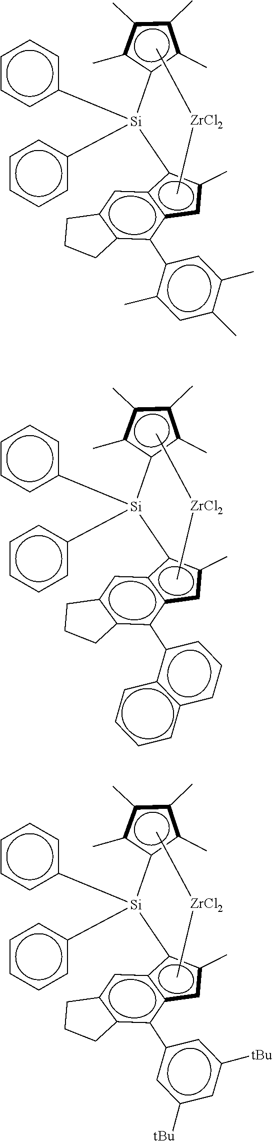

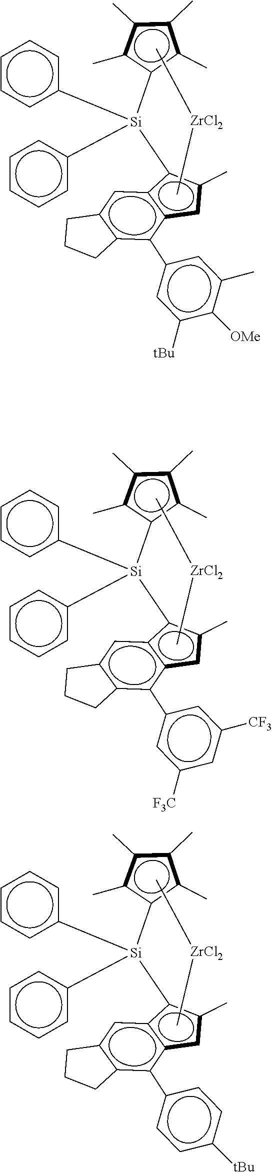

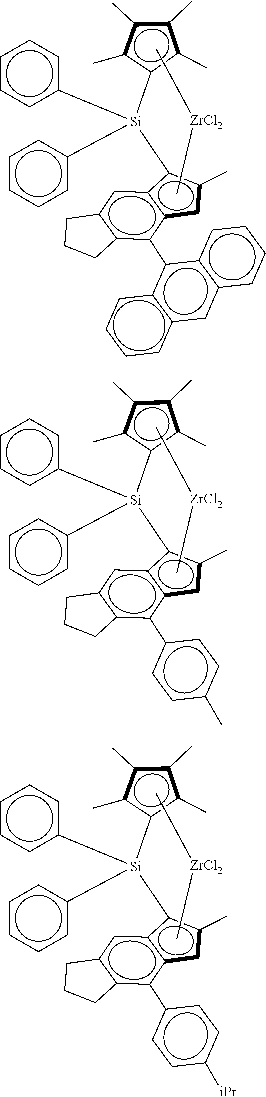

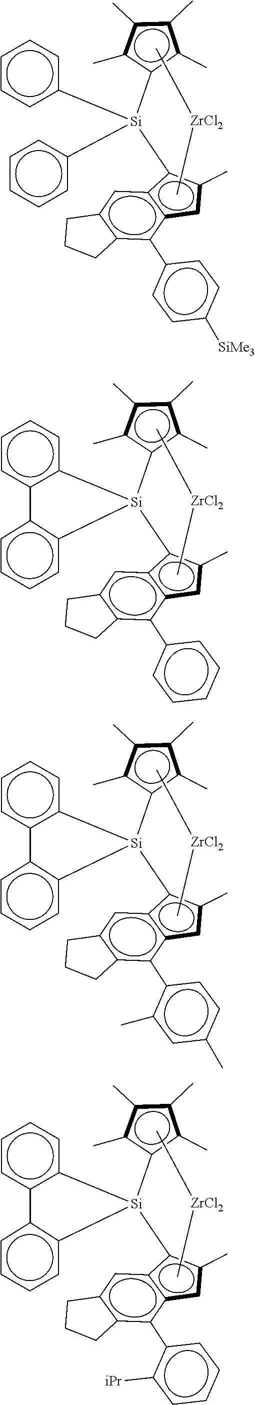

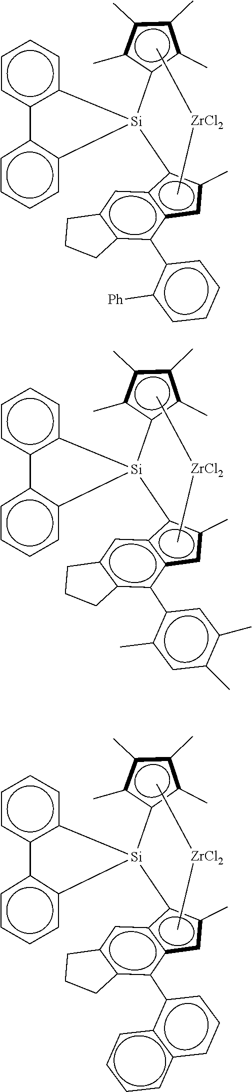

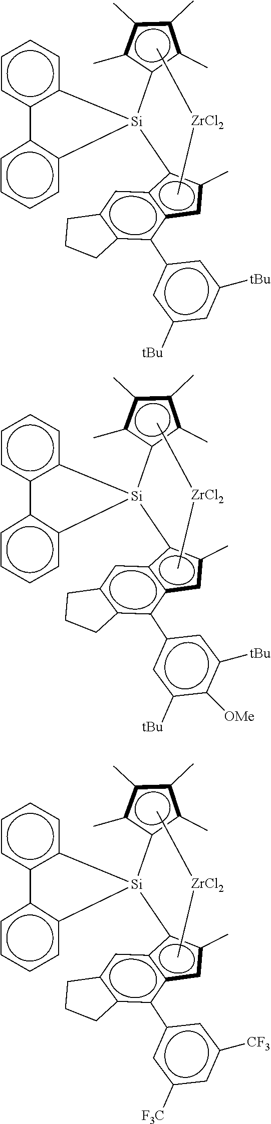

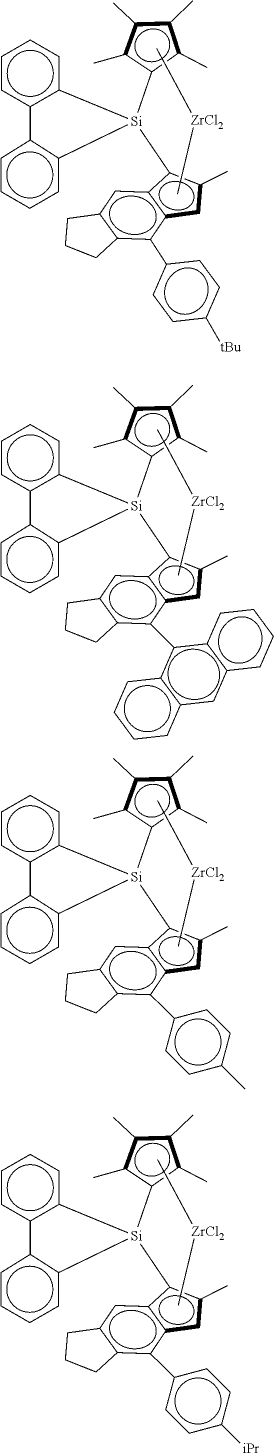

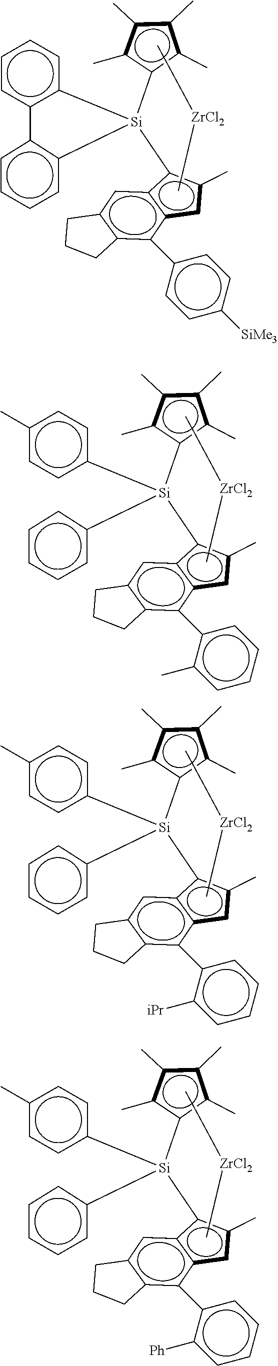

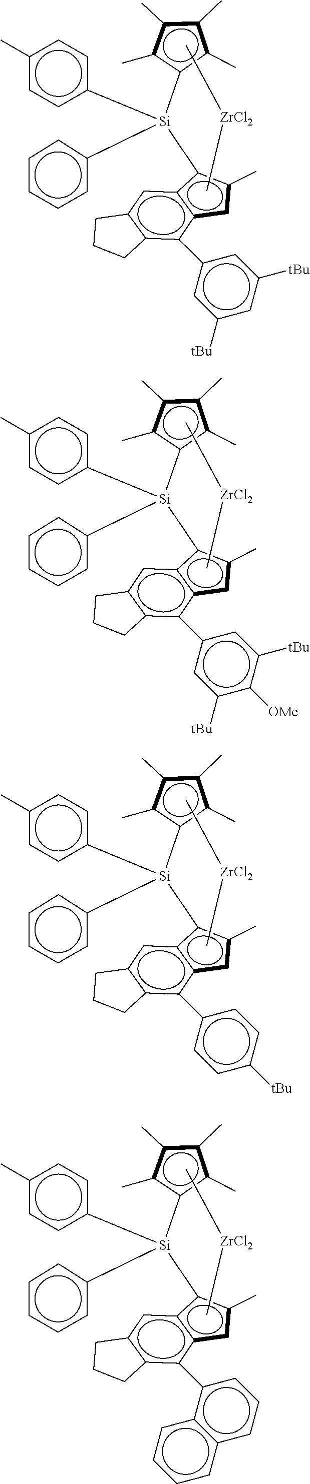

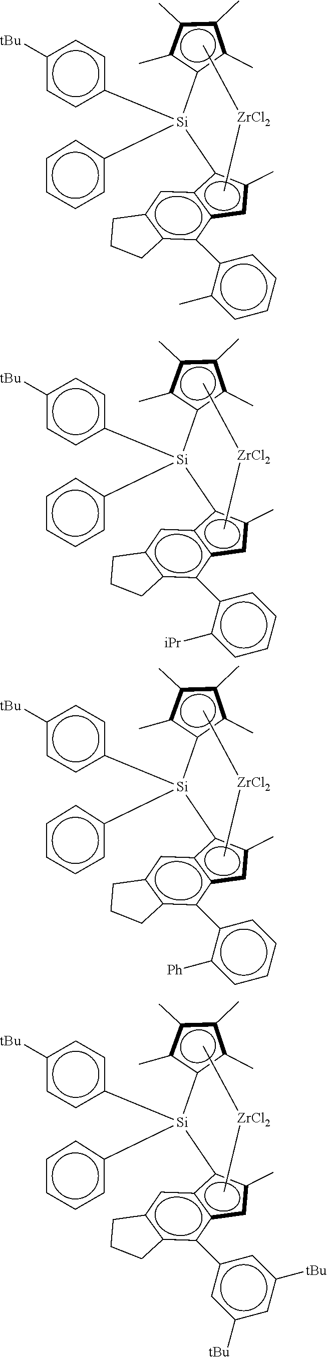

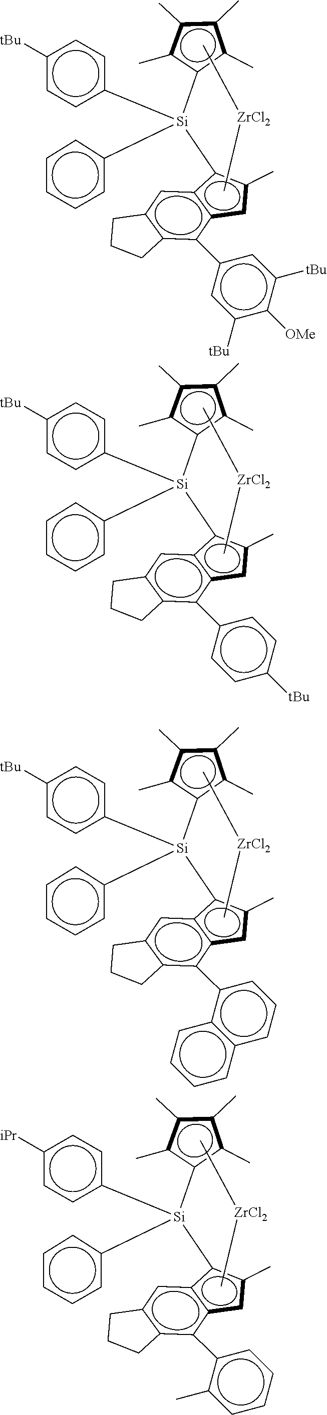

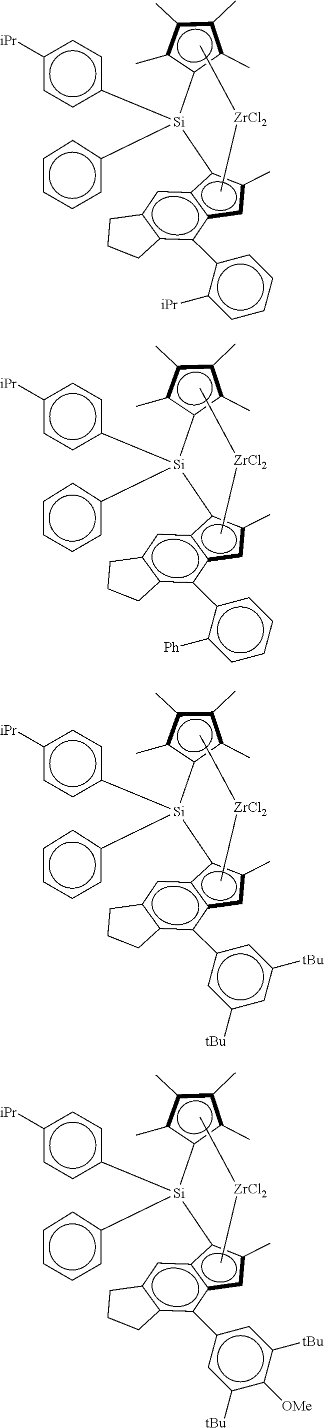

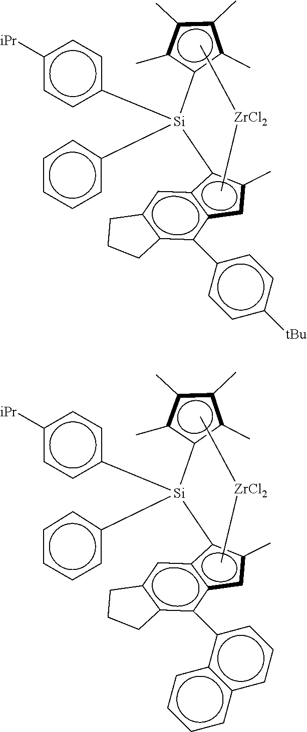

### Activators

The bridged metallocene compounds can be activated for polymerization catalysis in any manner sufficient to allow coordination or cationic polymerization. This can be achieved for coordination polymerization when one ligand can be abstracted and another will either allow insertion of the unsaturated monomers or will be similarly abstractable for replacement with a ligand that allows insertion of the unsaturated monomer (labile ligands), e.g., alkyl, silyl, or hydride. The traditional activators of coordination polymerization art are suitable, for example, Lewis acids such as aluminoxane compounds, and ionizing, anion precursor compounds that abstract one so as to ionize the bridged metallocene metal center into a cation and provide a counter-balancing noncoordinating anion.

For example, suitable activators can include a cationic component. In any embodiment, the cationic component can have the formula [R¹R²R³AH]⁺, where A is nitrogen, R¹ and R² are together a —(CH₂)ₐ— group, where a is 3, 4, 5, or 6 and form, together with the nitrogen atom, a 4-, 5-, 6-, or 7-membered non-aromatic ring to which, via adjacent ring carbon atoms, optionally one or more aromatic or heteroaromatic rings can be fused, and R³ is C₁, C₂, C₃, C₄, or C₅ alkyl, or N-methylpyrrolidinium or N-methylpiperidinium. Alternatively, in any embodiment, the cationic component can have the formula [RₙAH4_ₙ]⁺, where A is nitrogen, n is 2 or 3, and all R are identical and are C₁ to C₃ alkyl groups, such as trimethylammonium, trimethylanilinium, triethylammonium, dimethylanilinium, and dimethylammonium.

Suitable activators can also be or include an anionic component, [Y]. The anionic component can be a non-coordinating anion (NCA), having the formula [B(R⁴)₄]⁻, where R⁴ is an aryl group or a substituted aryl group, of which the one or more substituents are identical or different and are selected from the group consisting of alkyl, aryl, a halogen atom, halogenated aryl, and haloalkylaryl groups. The substituents can be perhalogenated aryl groups, or perfluorinated aryl groups, including, perfluorophenyl, perfluoronaphthyl and perfluorobiphenyl.

Suitable activators can also be or include a non-coordinating anion (NCA) represented by the formula: (Z)d⁺(Ad⁻), wherein Z is (L−H) or a reducible Lewis Acid, L is a Lewis base; H is hydrogen; (L−H)+ is a Bronsted acid; Ad− is a non-coordinating anion having the charge d−; and d is an integer from 1 to 3.

Suitable activators can also be or include a non-coordinating anion (NCA) represented by the formula: (Z)d+(Ad−), wherein Ad− is a non-coordinating anion having the charge d−; d is an integer from 1 to 3, and Z is a reducible Lewis acid represented by the formula: (Ar3C+), where Ar is aryl or aryl substituted with a heteroatom, a C₁ to C₄₀ hydrocarbyl, or a substituted C₁ to C₄₀ hydrocarbyl.

A ratio of the activator(s) to catalyst metal center can be at least 1:100, or at least 1:250, or at least 1:1500.

Together, the cationic and anionic components of the catalysts systems disclosed herein form an activator compound. In any embodiment, the activator can be N,N-dimethylanilinium-tetra(perfluorophenyl)borate, N,N-dimethylanilinium-tetra(perfluoronaphthyl)borate, N,N-dimethylanilinium-tetrakis(perfluorobiphenyl)borate, N,N-dimethylanilinium-tetrakis(3,5-bis(trifluoromethyl)phenyl)borate, triphenylcarbenium-tetra(perfluorophenyl)borate, triphenylcarbenium-tetra(perfluoronaphthyl)borate, triphenylcarbenium-tetrakis(perfluorobiphenyl)borate, or triphenylcarbenium-tetrakis(3,5-bis(trifluoromethyl)phenyl)borate.

See also International Publication Nos. WO2021/162748; WO2013/134038; WO2000/024793, each of which is incorporated herein by reference, for detailed descriptions of suitable catalyst systems.

### Supports

The silane bridged metallocenes can be supported or unsupported. When supported, any suitable support material can be used. Suitable support materials can include, but are not limited to, Al₂O₃, ZrO₂, SiO₂, SiO₂/Al₂O₃, SiO₂/TiO₂, silica clay, silicon oxide/clay, or mixtures thereof. Silica is preferred.

### Polymerization

Any conventional solution, slurry, or gas phase polymerization process can be used to make an ethylene copolymer using the diphenylsilane bridged metallocene catalyst provided herein. Preferably, a solution or gas phase process is used. For making propylene homopolymers or ethylene-propylene random copolymers using the diphenylsilane bridged metallocene catalyst provided herein, any conventional solution or slurry or gas phase polymerization process can be used. Preferably, a solution or slurry process is used.

Solution polymerization is a bulk polymerization process, which refers to a polymerization process in which the monomers and/or comonomers being polymerized are used as a solvent or diluent using little or no inert solvent as a liquid or diluent. A small fraction of inert solvent might be used as a carrier for a catalyst and a scavenger.

The term “solution polymerization” refers to a polymerization process in which the polymer is dissolved in a liquid polymerization medium, such as an inert solvent, monomer(s), or blends thereof. A solution polymerization is typically homogeneous, which refers to a polymerization process where the polymer product is dissolved in the polymerization medium. Such systems are preferably not turbid as described in Oliveira, J. et al (2000), Ind. Eng. Chem. Res., v.29, pg. 4627. A homogeneous polymerization process is typically a process where at least 90 wt % of the product is soluble in the reaction media.

The term “slurry polymerization” means a polymerization process where a supported catalyst is employed and monomers are polymerized on the supported catalyst particles, and at least 95 wt % of polymer products derived from the supported catalyst are in granular form as solid particles (not dissolved in the diluent).

If the polymerization is carried out as a slurry (suspension) or solution polymerization, an inert solvent or diluent can be used. Suitable diluents/solvents include non-coordinating, inert liquids. Examples include straight and branched-chain hydrocarbons, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof, such as can be found commercially (ISOPAR™); perhalogenated hydrocarbons, such as perfluorinated C₄₋₁₀ alkanes, chlorobenzene, and aromatic and alkylsubstituted aromatic compounds, such as benzene, toluene, mesitylene, and xylene. Suitable diluents/solvents also include liquid olefins which can act as monomers or co-monomers including ethylene, propylene, 1-butene, 1-hexene, 1-pentene, 3-methyl-1-pentene, 4-methyl-1-pentene, 1-octene, 1-decene, and mixtures thereof. In a preferred embodiment, aliphatic hydrocarbon solvents are used as the solvent, such as isobutane, butane, pentane, isopentane, hexanes, isohexane, heptane, octane, dodecane, and mixtures thereof; cyclic and alicyclic hydrocarbons, such as cyclohexane, cycloheptane, methylcyclohexane, methylcycloheptane, and mixtures thereof. In another embodiment, the diluent/solvent is not aromatic, preferably aromatics are present in the diluent/solvent at less than 1 wt %, preferably less than 0.5 wt %, preferably less than 0 wt % based upon the weight of the diluents/solvents. It is also possible to use mineral spirit or a hydrogenated diesel oil fraction as a solvent. Toluene can also be used. The polymerization is preferably carried out in the liquid monomer(s). If inert solvents are used, the monomer(s) is (are) typically metered in gas or liquid form.

### Comonomers

The at least one other comonomer can include any one or more C₄ to C₂₀ olefins. The C₄ to C₂₀ comonomers can be linear, branched, or cyclic. Suitable C₄ to C₂₀ cyclic olefins can be strained or unstrained, monocyclic or polycyclic, and can optionally include heteroatoms and/or one or more functional groups. The reactor C₂ concentration can range from 0.1 to 40.0 wt %; 1 to 40.0 wt %; 1 to 35 wt %; 2 to 20 wt %, 3 to 10 wt %; or 0.1 to 10 wt %. The reactor C₄ to C₂₀ comonomers concentration can range from 0.1-50 wt %; 1 to 35 wt %, 2-20 wt %, or 3-10 wt %.

Specific examples of comonomers include butene, pentene, hexene, heptene, octene, nonene, decene, undecene, dodecene, norbornene, norbornadiene, dicyclopentadiene, cyclopentene, cycloheptene, cyclooctene, cyclooctadiene, cyclododecene, 7-oxanorbornene, 7-oxanorbornadiene, substituted derivatives thereof, and isomers thereof, preferably hexene, heptene, octene, nonene, decene, dodecene, cyclooctene, 1,5-cyclooctadiene, 1-hydroxy-4-cyclooctene, 1-acetoxy-4-cyclooctene, 5-methylcyclopentene, cyclopentene, dicyclopentadiene, norbornene, norbornadiene, and their respective homologs and derivatives, and are preferably norbornene, norbornadiene, and dicyclopentadiene.

In a preferred embodiment, one or more dienes (diolefin comonomer) are added to the polymerization process. The diene can be present in the polymer produced herein at up to 10 wt %, preferably at 0.00001 to 8.0 wt %, preferably 0.002 to 8.0 wt %, even more preferably 0.003 to 8.0 wt %, based upon the total weight of the composition. In some embodiments, 500 ppm or less of diene is added to the polymerization, preferably 400 ppm or less, preferably 300 ppm or less. In other embodiments, at least 50 ppm of diene is added to the polymerization, or 100 ppm or more, or 150 ppm or more.

Suitable diolefin comonomers include any hydrocarbon structure, preferably C₄ to C₃₀, having at least two unsaturated bonds, where at least one of the unsaturated bonds are readily incorporated into a polymer chain during chain growth. It is further preferred that the diolefin comonomers be selected from alpha, omega-diene monomers (i.e., di-vinyl monomers). More preferably, the diolefin comonomers are linear di-vinyl monomers, most preferably those containing from 4 to 30 carbon atoms. Specific examples of preferred dienes include butadiene, pentadiene, hexadiene, heptadiene, octadiene, nonadiene, decadiene, undecadiene, dodecadiene, tridecadiene, tetradecadiene, pentadecadiene, hexadecadiene, heptadecadiene, octadecadiene, nonadecadiene, icosadiene, heneicosadiene, docosadiene, tricosadiene, tetracosadiene, pentacosadiene, hexacosadiene, heptacosadiene, octacosadiene, nonacosadiene, triacontadiene, particularly preferred dienes include 1,6-heptadiene, 1,7-octadiene, 1,8-nonadiene, 1,9-decadiene, 1,10-undecadiene, 1,11-dodecadiene, 1,12-tridecadiene, 1,13-tetradecadiene, and low molecular weight polybutadienes (Mw less than 1000 g/mol). Preferred cyclic dienes include cyclopentadiene, 5-vinyl-2-norbornene, norbornadiene, 5-ethylidene-2-norbornene, divinylbenzene, and dicyclopentadiene or higher ring containing diolefins with or without substituents at various ring positions.

### Polymers

In some embodiments, the polymers produced from the diphenyl silane bridged metallocenes provided herein can be homopolymers of propylene or copolymers of propylene having from about 0.1 wt % to about 50 wt % based on the total amount of polymer (such as from 1 wt % to 20 wt %) of one or more of C₂ or C₄ to C₂₀ olefin comonomer, based on a total amount of propylene copolymer, such as from about 0.5 wt % to about 18 wt %, such as from about 1 wt % to about 15 wt %, such as from about 3 wt % to about 10 wt %) of one or more of C₂ or C₄ to C₂₀ olefin comonomer (such as ethylene or C₄ to C₁₂ alpha-olefin, such as ethylene, butene, hexene, octene, decene, dodecene, such as ethylene, butene, hexene, octene, or C₄-C₁₄ α,ω-dienes such as butadiene, 1,5-hexadiene, 1,4-heptadiene, 1,6-heptadiene, 1,7-octadiene, 1,8-nonadiene, 1,9-decadiene, 1,10-undecadiene, 1,11-dodecadiene, 1,12-tridecadiene, 1,13-tetradecadiene).

The propylene homopolymer or propylene copolymer produced herein may have some level of isotacticity and can be isotactic or highly isotactic. As used herein, “isotactic” is defined as having at least 10% isotactic pentads according to analysis by ¹³C NMR as described in US 2008/0045638 at paragraph [0613] et seq. As used herein, “highly isotactic” is defined as having at least 60% isotactic pentads according to analysis by ¹³C NMR. In at least one embodiment, a propylene homopolymer having at least about 85% isotacticity, such as at least about 90% isotacticity can be produced herein. In another embodiment, the propylene polymer produced can be atactic. Atactic polypropylene is defined to be less than 10% isotactic or syndiotactic pentads according to analysis by ¹³C NMR.

Unless otherwise indicated, the distribution and the moments of molecular weight (Mw, Mn, Mz, Mw/Mn, etc.), the comonomer content, and the branching index (g′) are determined by using a high temperature Gel Permeation Chromatography (Polymer Char GPC-IR) equipped with a multiple-channel band-filter based Infrared detector IR5 with a multiple-channel band filter based infrared detector ensemble IR5 with band region covering from about 2,700 cm⁻¹ to about 3,000 cm⁻¹ (representing saturated C—H stretching vibration), an 18-angle light scattering detector and a viscometer. Three Agilent PLgel 10-μm Mixed-B LS columns are used to provide polymer separation. Reagent grade 1,2,4-trichlorobenzene (TCB) (from Sigma-Aldrich) comprising ~300 ppm antioxidant BHT can be used as the mobile phase at a nominal flow rate of ~1.0 mL/min and a nominal injection volume of ~200 μL. The whole system including transfer lines, columns, and detectors can be contained in an oven maintained at ~145 °C. A given amount of sample can be weighed and sealed in a standard vial with ~10 μL flow marker (heptane) added thereto. After loading the vial in the auto-sampler, the oligomer or polymer may automatically be dissolved in the instrument with ~8 mL added TCB solvent at ~160 °C with continuous shaking. The sample solution concentration can be from ~0.2 to ~2.0 mg/ml, with lower concentrations used for higher molecular weight samples. The concentration, c, at each point in the chromatogram can be calculated from the baseline-subtracted IR5 broadband signal, l, using the equation: c=αl, where α is the mass constant determined with polyethylene or polypropylene standards. The mass recovery can be calculated from the ratio of the integrated area of the concentration chromatography over elution volume and the injection mass which is equal to the pre-determined concentration multiplied by injection loop volume. The conventional molecular weight (IR MW) is determined by combining universal calibration relationship with the column calibration which is performed with a series of monodispersed polystyrene (PS) standards ranging from 700 to 10M gm/mole. The MW at each elution volume is calculated with following equation:

$$log M = \frac{log ( {K}_{PS} / K )}{α + 1} + \frac{{α}_{PS} + 1}{α + 1} log {M}_{PS}$$

where the variables with subscript “PS” stand for polystyrene while those without a subscript are for the test samples. In this method, α_{PS}=0.67 and K_{PS}=0.000175, α and K for other materials are as calculated as described in the published in literature (e.g., Sun, T. et al. (2001) Macromolecules, v.34, pg. 6812), except that for purposes of this present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.0002288 for linear propylene polymers, and α=0.695 and K=0.000181 for linear butene polymers. Concentrations are expressed in g/cm³, molecular weight is expressed in g/mole, and intrinsic viscosity (hence K in the Mark-Houwink equation) is expressed in dL/g unless otherwise noted.

The comonomer composition is determined by the ratio of the IR5 detector intensity corresponding to CH₂ and CH3 channel calibrated with a series of PE and PP homo/copolymer standards whose nominal value are predetermined by NMR or FTIR. In particular, this provides the methyls per 1,000 total carbons (CH₃/1000TC) as a function of molecular weight. The short-chain branch (SCB) content per 1,000TC (SCB/1000TC) is then computed as a function of molecular weight by applying a chain-end correction to the CH₃/1000TC function, assuming each chain to be linear and terminated by a methyl group at each end. The weight % comonomer is then obtained from the following expression in which f is 0.3, 0.4, 0.6, 0.8, and so on for C₃, C₄, C₆, C₈, and so on co-monomers, respectively:

w2=f*SCB/1000TC.

The bulk composition of the polymer from the GPC-IR and GPC-4D analyses is obtained by considering the entire signals of the CH₃ and CH2 channels between the integration limits of the concentration chromatogram. First, the following ratio is obtained

$$Bulk I R ratio = \frac{Area of C {H}_{3} signal within integration limits}{Area of C {H}_{2} signal within integration limits} .$$

Then the same calibration of the CH₃ and CH₂ signal ratio, as mentioned previously in obtaining the CH₃/1000TC as a function of molecular weight, is applied to obtain the bulk CH₃/1000TC. A bulk methyl chain ends per 1,000TC (bulk CH₃end/1000TC) is obtained by weight-averaging the chain-end correction over the molecular-weight range. Then

w2b=f*bulk CH3/1000TC

bulk SCB/1000TC=bulk CH3/1000TC−bulk CH3end/1000TC

and bulk SCB/1000TC is converted to bulk w2 in the same manner as described above.

The LS detector is the 18-angle Wyatt Technology High Temperature DAWN HELEOSII. The LS molecular weight (M) at each point in the chromatogram is determined by analyzing the LS output using the Zimm model for static light scattering (Light Scattering from Polymer Solutions; Huglin, M. B., Ed.; Academic Press, 1972.):

$$\frac{{K}_{o} c}{Δ R ( θ )} = \frac{1}{MP ( θ )} + 2 {A}_{2} c .$$

Here, ΔR(θ) is the measured excess Rayleigh scattering intensity at scattering angle θ, c is the polymer concentration determined from the IR5 analysis, A₂ is the second virial coefficient, P(θ) is the form factor for a monodisperse random coil, and K_{O} is the optical constant for the system:

$${K}_{o} = \frac{4 {π}^{2} {{n}^{2} ( dn / dc )}^{2}}{{λ}^{4} {N}_{A}}$$

where NA is Avogadro's number, and (dn/dc) is the refractive index increment for the system. The refractive index, n=1.500 for TCB at 145 °C and λ=665 nm. For analyzing polyethylene homopolymers, ethylene-hexene copolymers, and ethylene-octene copolymers, dn/dc=0.1048 ml/mg and A₂=0.0015; for analyzing ethylene-butene copolymers, dn/dc=0.1048*(1−0.00126*w2) ml/mg and A₂=0.0015 where w2 is weight percent butene comonomer.

A high temperature Agilent (or Viscotek Corporation) viscometer, which has four capillaries arranged in a Wheatstone bridge configuration with two pressure transducers, is used to determine specific viscosity. One transducer measures the total pressure drop across the detector, and the other, positioned between the two sides of the bridge, measures a differential pressure. The specific viscosity, η_{S}, for the solution flowing through the viscometer is calculated from their outputs. The intrinsic viscosity, [η], at each point in the chromatogram is calculated from the equation [η]=η_{S}/c, where c is concentration and is determined from the IR5 broadband channel output. The viscosity MW at each point is calculated as M=K_{PS}M^{α}^{_{PS}}⁺¹/[η], where αₚₛ is 0.67 and Kₚₛ is 0.000175.

The branching index (g′ᵥᵢₛ) is calculated using the output of the GPC-IR5-LS-VIS method as follows. The average intrinsic viscosity, [η]avg, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits.

The branching index g′ᵥᵢₛ is defined as:

$${g}_{vis}^{′} = \frac{{[ η ]}_{avg}}{{KM}_{v}^{α}} ,$$

where M_{V} is the viscosity-average molecular weight based on molecular weights determined by LS analysis and the K and α are for the reference linear polymer, which are, for purposes of this present disclosure and claims thereto, α=0.705 and K=0.0000229 for ethylene-propylene copolymers and ethylene-propylene-diene terpolymers, α=0.695 and K=0.000579 for linear ethylene polymers, α=0.705 and K=0.0002288 for linear propylene polymers, α=0.695 and K=0.000181 for linear butene polymers. Concentrations are expressed in g/cm³, molecular weight is expressed in g/mole, and intrinsic viscosity (hence K in the Mark-Houwink equation) is expressed in dL/g unless otherwise noted. Calculation of the w2b values is as discussed above.

In one or more specific embodiments, the ethylene-propylene random copolymers (RCP) produced herein can have:
a) ethylene content of from 0.1 to 10 wt %, based on the total weight of the copolymer, such as 0.2-10 wt %; 0.5-10 wt %; 1-10 wt %; 2-10 wt %; or 3-8 wt %;
b) an Mw of from about 5,000 to about 1,000,000 g/mol (such as from about 25,000 to about 750,000 g/mol, such as from about 50,000 to about 500,000 g/mol, such as from about 80,000 to about 300,000 g/mol, such as from about 100,000 to about 250,000 g/mol, or 5,000 to 500,000 g/mol, or from 5,000 to 350,000 or from 10,000 to 250,000) as determined by GPC-4D;
c) a molecular weight distribution, MWD, (Mw/Mn) of greater than about 2, such as from about 2 to about 30, such as from about 3 to about 20, such as from about 4 to about 10 as determined by GPC-4D;
d) a melt flow rate (MFR) of from about 0.1 dg/min to about 1,000 dg/min, from about 1 dg/min to about 100 dg/min, from about 20 dg/min to about 70 dg/min, or from about 5 to about 10 dg/min as determined by ASTM D1238 (230 °C, 2.16 kg); and
e) a Tm of greater than about 80 °C, such as from about 120 °C to about 165 °C, such as from about 140 °C to about 160 °C, such as from about 145 °C to about 155 °C as determined by the differential scanning calorimetry procedure DSC-2 described below.

In one or more specific embodiments, ethylene-propylene elastomers and rubbers (EP) produced herein can have:
a) ethylene content of from 0.1 to 50 wt %, based on the total weight of the copolymer, such as 1-35 wt %, 2-20 wt %, 3-10 wt %, 10-40 wt %; 10-25 wt %; 15-35 wt %, or 20-40 wt %;
b) an Mw of from about 5,000 to about 1,000,000 g/mol (such as from about 25,000 to about 750,000 g/mol, such as from about 50,000 to about 500,000 g/mol, such as from about 80,000 to about 300,000 g/mol, or 5,000 to 500,000 g/mol, or from 5,000 to 350,000 or from 10,000 to 250,000, as determined by GPC-4D;
c) a molecular weight distribution, MWD, (Mw/Mn) of greater than about 2, such as from about 2 to about 30, such as from about 3 to about 20, such as from about 4 to about 10 as determined by GPC-4D; and
d) a melt flow rate (MFR) of from about 0.1 dg/min to about 1,000 dg/min, from about 1 dg/min to about 100 dg/min, from 20 dg/min to 70 dg/min, or from about 5 to about 10 dg/min as determined by ASTM D1238 (230 °C, 2.16 kg).

In one or more specific embodiments, propylene homopolymers (hPP) produced herein can have:
a) an Mw of from about 5,000 to about 1,000,000 g/mol (such as from about 25,000 to about 750,000 g/mol, such as from about 50,000 to about 500,000 g/mol, such as from about 80,000 to about 300,000 g/mol, such as from about 80,000 to about 200,000 g/mol, or 5,000 to 500,000 g/mol, or from 5,000 to 350,000 or from 10,000 to 250,000) as determined by GPC-4D;
b) a molecular weight distribution, MWD, (Mw/Mn) of greater than about 2, such as from about 2 to about 30, such as from about 3 to about 20, such as from about 4 to about 10 as determined by GPC-4D;
c) a g′ᵥᵢₛ of greater than about 0.6, such as from about 0.7 to about 1, such as from 0.8 to 0.95, such as from about 0.7 to about 0.90 as determined by GPC-4D;
d) a melt flow rate (MFR) of from about 0.1 dg/min to about 3,000 dg/min, from about 1 dg/min to about 100 dg/min, from about 10 dg/min to about 100 dg/min, or from about 5 to about 10 dg/min as determined by ASTM D1238 (230 °C, 2.16 kg); and
e) a melting temperature (Tm) of greater than about 120 °C, such as from about 130 °C to about 165 °C, such as from about 140 °C to about 160 °C, such as from about 145 °C to about 155 °C as determined by the differential scanning calorimetry procedure DSC-2 described below.

### EXAMPLES

The foregoing discussion can be further described with reference to the following non-limiting examples. Three silane bridged metallocene structures (I1, I2, and I3) were prepared and used to make propylene homopolymers and ethylene-propylene copolymers. Two comparative metallocene catalysts (C₁ and C₂) were also prepared and tested. The five (5) catalyst structures are shown below.

Comparative Metallocene Catalysts (C₁ and C₂):

### Inventive Silane Bridged Metallocenes Structure

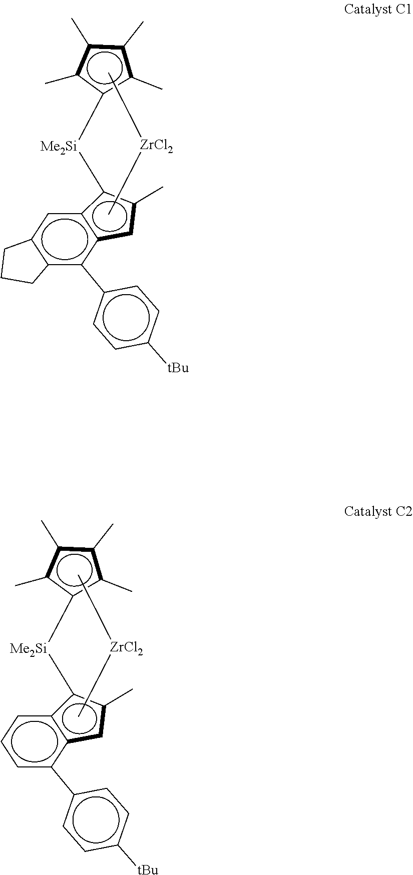

### s (I1, I2, and I3):

Catalysts C₁, C₂ and I₁ were prepared from silafluorenyldichloride using the following traditional route:

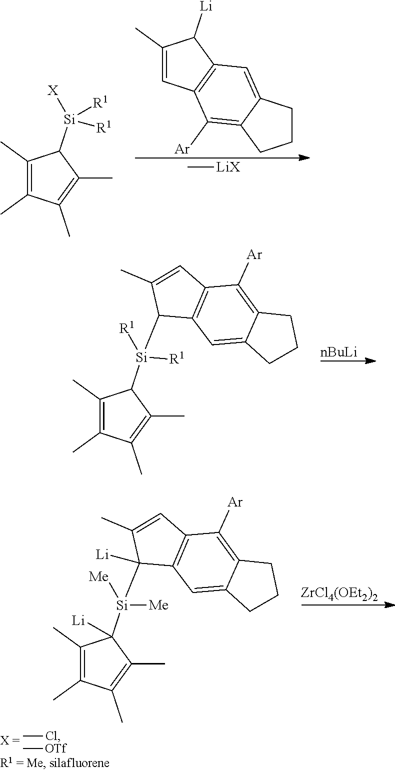

Catalysts I₂ and I₃ were prepared using the following modified one pot technique:

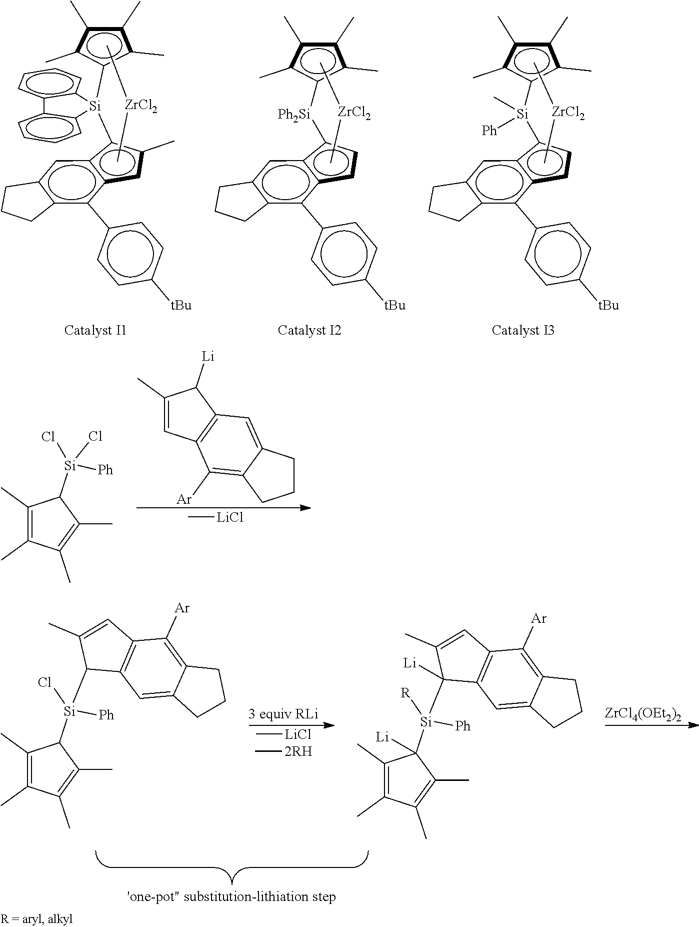

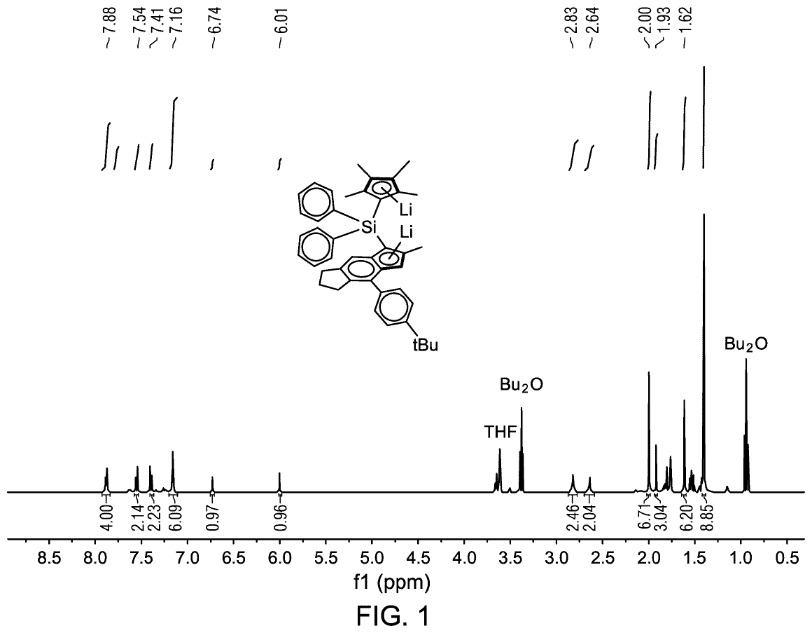

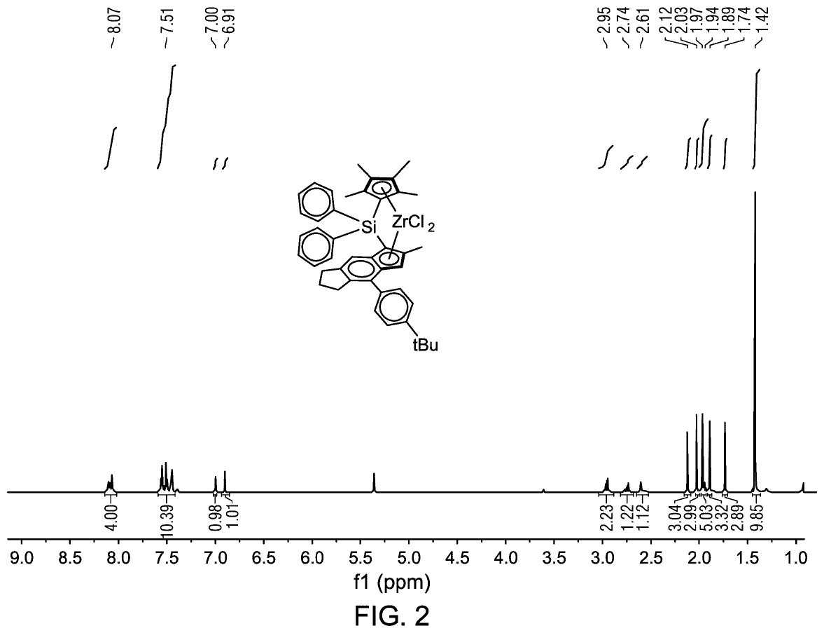

FIG. 1 shows a representative spectrum of the in-situ substitution-lithiation for catalyst I₂. FIG. 2 shows the spectrum of the isolated catalyst I₂, which confirms excellent purity. The spectrum demonstrates excellent purity of the isolated material.

Catalysts C₁ and C₂ were prepared according to previously reported procedures, such as the ones described in U.S. Pat. No. 9,266,910 and in WO2021/034459A1.

Catalyst I₁ was prepared according to the following Scheme 1:

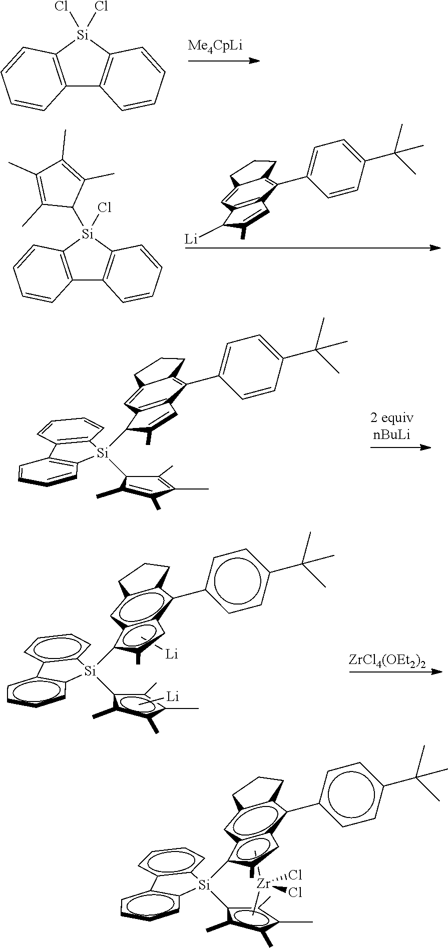

### Preparation of 9-Chloro-9-(2,3,4,5-tetramethylcyclopentadienyl)-silafluorene

To a precooled, stirring solution of dichlorosilafluorene (0.505 g, 2.01 mmol) in diethyl ether (40 mL), sodium tetramethylcyclopentadienide (0.290 g, 2.01 mmol, 1 equiv.) was added. The reaction was stirred at room temperature for 1.5 hours. The reaction was concentrated under a stream of nitrogen and then under high vacuum. The residue was extracted with pentane and filtered over Celite. The filtrate was concentrated under a stream of nitrogen and then under high vacuum to afford the product as an off-white solid (0.489 g, 72% yield). ¹H NMR (C₆D6): δ 7.46-7.39 (m, 4H), 7.12 (td, 2H, J=7.6, 1.4 Hz), 7.01 (td, 2H, J=7.4, 1.0 Hz), 3.64-3.27 (br s, 1H), 1.87 (s, 6H), 1.54 (s, 6H).

### Preparation of 4-(4-Tert-butylphenyl)-2-methyl-1,5,6,7-tetrahydro-s-indacenyl) (2,3,4,5-tetramethyl cyclopentadienyl) silafluorene

To a stirring solution of 9-Chloro-9-(2,3,4,5-tetramethylcyclopentadienyl)-silafluorene (0.140 g, 0.416 mmol) in tetrahydrofuran (10 mL), a solution of lithium 4-(4-tert-butylphenyl)-1,5,6,7-tetrahydro-s-indacenide (0.128 g, 0.416 mmol, 1 equiv.) in tetrahydrofuran (5 mL) was added. The reaction was stirred at room temperature overnight. The reaction was concentrated under a stream of nitrogen and then under high vacuum. The residue was extracted with dichloromethane (10 mL, then 5 mL) and filtered over Celite. The combined dichloromethane extracts were concentrated under a stream of nitrogen and then under high vacuum. The resulting residue was stirred in hexane (5 mL) and filtered over Celite. The hexane extract was concentrated under a stream of nitrogen and then under high vacuum to afford the product as an off-white foam (0.237 g, 94% yield). ¹H NMR (C₆D₆): δ 7.78 (s, 1H), 7.52-7.37 (m, 7H), 7.26 (d, 1H, J=7.1 Hz), 7.15-7.09 (m, 1H), 7.01 (td, 1H, J=7.3, 1.0 Hz), 6.95 (td, 1H, J=7.3, 1.0 Hz), 6.49 (dd, 1H, J=7.0, 1.2 Hz), 6.38 (s, 1H), 4.23 (s, 1H), 4.00 (s, 1H), 3.12-2.82 (m, 4H), 2.37 (s, 3H), 2.05-1.88 (m, 2H), 1.86 (s, 3H), 1.50 (s, 3H), 1.43 (s, 3H), 1.37 (s, 3H), 1.30 (s, 9H).

### Preparation of lithium (4-(4-tert-butylphenyl)-2-methyl-1,5,6,7-tetrahydro-s-indacenidyl) (2,3,4,5-tetramethylcyclopentadienidyl)silafluorene

To a precooled, stirring solution of (4-(4-tert-butylphenyl)-2-methyl-1,5,6,7-tetrahydro-s-indacenyl)(2,3,4,5-tetramethylcyclopentadienyl)-silafluorene (0.237 g, 0.393 mmol) in diethyl ether (10 mL), n-butyllithium (0.33 mL, 2.74 M in hexane, 0.90 mmol, 2.3 equiv.) was added. The reaction was stirred at room temperature for 2 hours. The reaction was concentrated under a stream of nitrogen and then under high vacuum. The residue was stirred in hexane (2 mL). The resulting suspension was filtered on a plastic, fritted funnel. The filtered solid was collected and concentrated under high vacuum to afford the product as an orange solid (0.125 g, 45% yield), containing diethyl ether (0.82 equiv.). ¹H NMR (400 MHz, C4H8O): δ 7.99 (d, 2H, J=7.0 Hz), 7.79 (d, 2H, J=7.7 Hz), 7.46 (d, 2H, J=8.4 Hz), 7.34 (d, 2H, J=8.4 Hz), 7.23 (td, 2H, J=7.5, 1.4 Hz), 7.16 (s, 1H), 7.11 (td, 2H, J=7.2, 1.1 Hz), 5.90 (s, 1H), 2.76 (t, 2H, J=7.0 Hz), 2.70 (t, 2H, J=7.0 Hz), 2.20 (s, 3H), 1.92 (s, 6H), 1.85 (s, 6H), 1.84-1.77 (m, 2H), 1.35 (s, 9H).

### Preparation of silafluorenyl (4-(4-tert-butylphenyl)-2-methyl-1,5,6,7-tetrahydro-s-indacenyl) (2,3,4,5-tetramethylcyclpentadenyl) zirconium dichloride (Catalyst I₁)

To a stirring suspension of zirconium chloride (0.048 g, 0.206 mmol, 1.15 equiv.) in diethyl ether (5 mL), a suspension of lithium (4-(4-tert-butylphenyl)-2-methyl-1,5,6,7-tetrahydro-s-indacenidyl)(2,3,4,5-tetramethylcyclopentadien-idyl)silafluorene (0.125 g, 0.179 mmol, containing 0.82 equiv. diethyl ether) in diethyl ether (10 mL) was added. The reaction was stirred at room temperature for 6 hours. The reaction was concentrated under a stream of nitrogen and then under high vacuum. The residue was extracted with dichloromethane (10 mL, then 5 mL) and filtered over Celite. The combined dichloromethane extracts were concentrated under a stream of nitrogen and then under high vacuum. The residue was stirred in hexane and then concentrated under a stream of nitrogen and then under high vacuum to afford the product as an orange-yellow solid (0.102 g, 74% yield). ¹H NMR (400 MHz, CD2Cl2): δ 8.73 (d, ¹H, J=8.0 Hz), 8.45 (dd, 1H, J=7.5, 0.9 Hz), 8.11 (ddd, 2H, J=9.4, 7.8, 1.2 Hz), 7.94 (s, 1H), 7.69-7.57 (m, 3H), 7.56-7.43 (m, 5H), 6.84 (s, 1H), 2.97 (t, 4H, J=7.2 Hz), 2.47 (s, 3H), 2.32 (s, 3H), 2.23 (s, 3H), 2.07-1.97 (m, 5H), 1.95 (s, 3H), 1.38 (s, 9H).

### Catalyst I₂ (R=Ph) was Prepared According to the Following Scheme 1

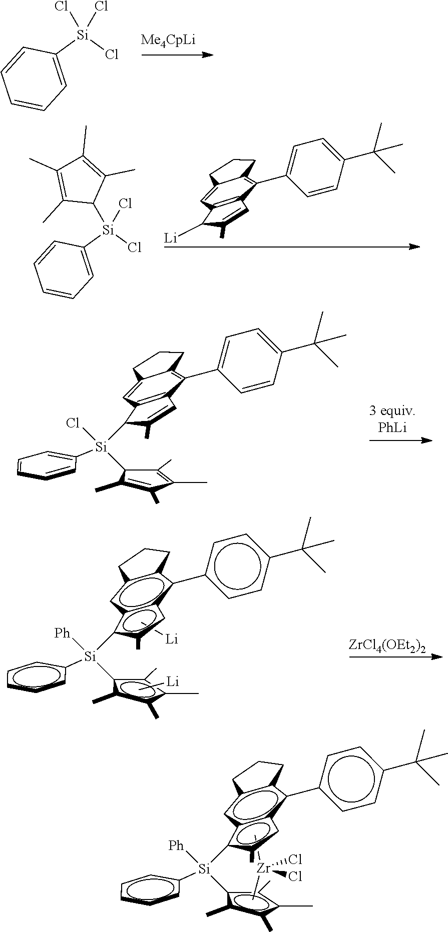

Me₄CpLi solid (2.02 g, 15.8 mmol) was slowly added to a pre-cooled (−30 °C) THE solution of PhSiC13 (3.35 g, 15.8 mmol). The reaction mixture was allowed to warm up to room temperature and was stirred overnight. After 18 hours, solvent was removed in vacuo and the residue was extracted with pentane (2×20 mL) and filtered over celite. Solvent removal afforded final product, which appeared to be of good purity (93% yield).

¹H NMR (C₆D₆) δ 7.47 (m, 2H) 7.02 (m, 1H) 6.97 (m, 2H), 3.21 (bs, 1H) 1.92 (bs, 6H) 1.47 (bs, 1H).

### Preparation of 4-(4-tert-butylphenyl)-2-methyl-1,5,6,7-tetrahydro-s-indacen-1-yl]-chloro-phenyl-(2,3,4,5-tetramethylcyclopenta-2,4-dien-1-yl)silane

In a 20 mL vial solid 4-(4-tBu-phenyl)-2-methyl-1,5,6,7-tetrahydro-s-indecenyl lithium (0.781 g, 2.5 mmol) was dissolved in 2 mL of THE and 5 mL of diethylether. Once cold, this solution was slowly transferred (via pipette) to pre-cooled (−30 °C) solution of dichloro-phenyl-(2,3,4,5-tetramethylcyclopenta-2,4-dien-1-yl)silane (1.5 g, 5.1 mmol) in diethylether. The reaction mixture was pale yellow and slightly cloudy upon completion of addition. After 1 hour, solvent was removed in vacuo and the residue was extracted with pentane and concentrated in vacuo. The yellow pentane solution was placed in a freezer. After 18 hours, yellow crystals deposited—the solution was decanted and the crystals were washed with 10 mL of pentane and dried in vacuo to afford spectroscopically pure product in 49% yield. ¹H NMR (C₆D₆) δ 7.74 (s, 1H), 7.48 (s, 2H), 7.41 (s, 4H), 7.08 (s, 1H), 7.00 (s, 2H), 6.77 (s, 1H), 3.99 (s, 1H), 3.81 (s, 1H), 2.87 (d, 4H), 2.16 (s, 3H), 1.99 (s, 3H), 1.86 (m, 2H), 1.72 (s, 3H), 1.55 (s, 3H), 1.44 (s, 3H), 1.30 (s, 9H).

### Preparation of dilithium-diphenyl(4-(4-tert-butylphenyl)-2-methyl-1,5,6,7-tetrahydro-s-indacenyl) (2,3,4,5-tetramethylcyclopentadienyl)silane

To a precooled, stirring solution of chloro(4-(4-tert-butylphenyl)-2-methyl-1,5,6,7-tetrahydro-s-indacenyl)(2,3,4,5-tetramethylcyclopentadienyl)phenylsilane (0.661 g, 1.17 mmol) in tetrahydrofuran (~40 mL), phenyllithium (1.7 mL of 2.1 M solution in dibutylether) was added. The reaction instantly became clear orange and was stirred at room temperature for 1 hour. After 1 hour, solvent was removed in vacuo to give an orange solid. The solid was washed with 2×10 mL of hexane and dried in vacuo to give a yellow solid. ¹H NMR indicates clean product with some residual THF and dibutyl ether in essentially quantitative yield. The material was used directly in the next step without further purification. ¹H NMR (THF-d₈) δ 7.88 (s, 4H), 7.54 (s, 2H), 7.41 (s, 2H), 7.16 (s, 6H), 6.74 (s, 1H), 6.01 (s, 1H), 2.83 (s, 2H), 2.64 (s, 2H), 2.00 (s, 6H), 1.93 (s, 3H), 1.62 (s, 6H), 1.40 (s, 9H). The last set of protons of the indacene backbone was obscured by residual dibutyl ether signals in the aliphatic region.

### Preparation of diphenylsilyl-(4-(4-tert-butylphenyl)-2-methyl-1,5,6,7-tetrahydro-s-indacenyl) (2,3,4,5-tetramethylcyclopentadienyl) zirconium dichloride (Catalyst I₂)

ZrCl₄(OEt₂)₂ (0.5 g, 1.31 mmol) was slowly added to a stirring suspension of dilithium-diphenyl(4-(4-tert-butylphenyl)-2-methyl-1,5,6,7-tetrahydro-s-indacenyl) (2,3,4,5-tetramethylcyclopentadienyl)silane (1.05 g, 1.31 mmol, contains 1.2 equiv. Bu₂O and 0.6 equiv. THF) in diethyl ether (~30 mL) at −30 °C. The reaction mixture was allowed to warm up to room temperature and was stirred overnight. After 18 hours, solvent was removed in vacuo to give a bright yellow residue. The residue was extracted with methylene chloride (2×25 mL), filtered over celite and concentrated to give yellow solids. The solids were triturated with pentane (20 mL) briefly stirred and filtered over glass frit. The solid was dried in vacuo to afford the final product in 66% yield. ¹H NMR (CD₂Cl₂) δ 8.07 (s, 4H), 7.51 (s, 10H), 7.00 (s, 1H), 6.91 (s, 1H), 2.95 (s, 2H), 2.74 (s, 1H), 2.61 (s, 1H), 2.12 (s, 3H), 2.03 (s, 3H), 1.97 (m, 5H), 1.89 (s, 3H), 1.74 (s, 3H), 1.42 (s, 9H).

### Catalyst I₃ (R=Me) was Prepared According to the Following Scheme 3

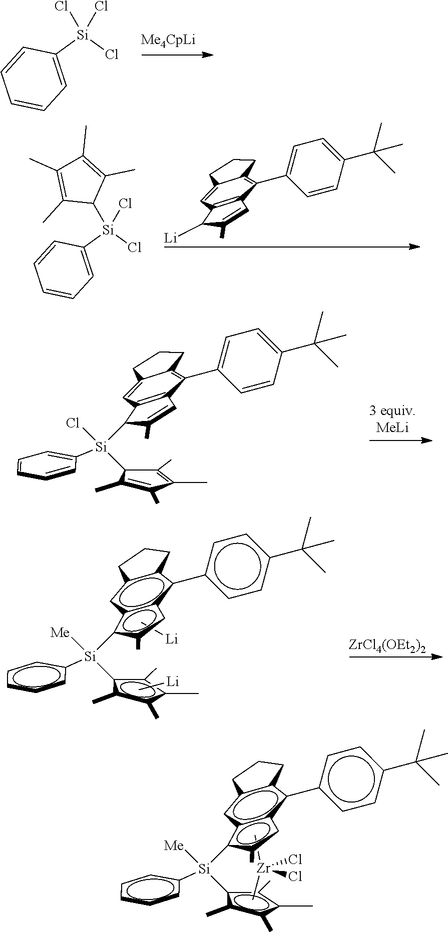

### Preparation of dilithium-(1-((4-(4-(tert-butyl)phenyl)-2-methyl-1,5,6,7-tetrahydro-s-indacen-1-yl)(methyl)(phenyl)silyl)-2,3,4,5-tetramethylcyclopenta-2,4-dien-1-yl)

To a precooled, stirring solution of chloro(4-(4-tert-butylphenyl)-2-methyl-1,5,6,7-tetrahydro-s-indacenyl)(2,3,4,5-tetramethylcyclopentadienyl)phenylsilane (0.156 g, 0.277 mmol) in tetrahydrofuran (~8 mL), methyllithium (0.537 mL of 1.6 M solution, 3.1 equiv.) was added. The reaction instantly became clear orange and was stirred at room temperature for 20 minutes. After 20 minutes, solvent was removed in vacuo to give a orange solid. The solid was washed with 2×10 mL of hexane and dried in vacuo to give a yellow solid. ¹H NMR indicates high purity product with ca 2 equiv. of residual THE in essentially quantitative yield. The material was used directly in the next step.

¹H NMR (THF-d₈) δ 7.65 (s, 2H), 7.53 (s, 2H), 7.41 (s, 2H), 7.16 (s, 4H), 5.95 (s, 1H), 2.81 (m, 4H), 2.11 (s, 3H), 1.98 (s, 6H), 1.85 (m, 8H), 1.40 (s, 9H), 0.88 (s, 3H).

### Preparation of (1-((4-(4-(tert-butyl)phenyl)-2-methyl-1,5,6,7-tetrahydro-s-indacen-1-yl)(methyl)(phenyl)silyl)-2,3,4,5-tetramethylcyclopenta-2,4-dien-1-yl)zirconium dichloride (Catalyst I₃)

ZrCl₄(OEt₂)₂ (0.11 g, 0.288 mmol) was slowly added to a stirring suspension of dilithium-(1-((4-(4-(tert-butyl)phenyl)-2-methyl-1,5,6,7-tetrahydro-s-indacen-1-yl)(methyl)(phenyl)silyl)-2,3,4,5-tetramethylcyclopenta-2,4-dien-1-yl) (0.20 g, 0.286 mmol) in diethyl ether (~30 mL) at −30 °C. The reaction mixture was allowed to warm up to room temperature and was stirred overnight. After 18 hours, solvent was removed in vacuo to give a bright yellow residue. The residue was extracted with methylene chloride (2×5 mL), filtered over celite and concentrated to give yellow solids. The solids were triturated with hexane (10 mL) briefly stirred and filtered over glass frit. ¹H NMR shows expected product in 45% yield. Two isomers are observed likely due to syn/anti relationship of asymmetric silane with respect to indacenyl ligand. ¹H NMR (CD₂Cl₂) δ 8.04 (s, 4H), 7.63-7.48 (overlapping m, 13H, both isomer), 6.89 (s, 1H, isomer 1), 6.84 (s, 1H, isomer 1), 6.83 (s, 1H, isomer 2), 3.12-2.50 (m, 8H, both isomers), 2.35 (s, 3H, isomer 1), 2.17 (s, 3H, isomer 2), 2.05-2.03 (two s, 6H, both isomers), 2.01-2.00 (two s, 6H, both isomers), 1.97 (s, 3H), 1.89 (s, 3H), 1.77 (s, 3H), 1.61 (s, 3H), 1.42 (s, 9H, isomer 1) 1.41 (s, 9 h, isomer 2) 1.28 (s, 3H, isomer 1), 1.14 (s, 3H, isomer 2).

### Solution Polymerization Procedure

Solution propylene polymerizations were carried out using high-throughput conditions. A pre-weighed glass vial insert and disposable stirring paddle were fitted to each reaction vessel of the reactor, which contains 48 individual reaction vessels. The reactor was then closed and propylene (typically 1-4 mL) was introduced. Then solvent (typically the isohexane) was added to bring the total reaction volume, including the subsequent additions, to 5 mL and the reactor vessels were heated to their set temperature (usually from about 50 °C to about 110 °C). The contents of the vessel were stirred at 800 rpm. An activator solution (typically 1.1-1000 molar equivalents of methyl alumoxane (MAO) in toluene was then injected into the reaction vessel along with 500 microliters of toluene. Catalyst (typically 0.50 mM in toluene, such as 20-40 nmol of catalyst) and another aliquot of toluene (500 microliters) were then added to initiate the reaction. Equivalence is determined based on the mol equivalents relative to the moles of the transition metal in the catalyst complex. The reaction was then allowed to proceed until a pre-determined amount of pressure had been taken up by the reaction. At this point, the reaction was quenched by pressurizing the vessel with compressed air. After the polymerization reaction, the glass vial insert containing the polymer product and solvent was removed from the pressure cell and the inert atmosphere glove box, and the volatile components were removed using a Genevac HT-12 centrifuge and Genevac VC3000D vacuum evaporator operating at elevated temperature and reduced pressure. The vial was then weighed to determine the yield of the polymer product. The resultant polymer was analyzed by Rapid GPC (see below) to determine the molecular weight and by DSC (see below) to determine melting point.

Table 1 shows catalyst activities and polymerization results for homopolypropylene (hPP) polymerized using the control catalysts C₁, C₂ and the inventive catalysts I₁-I₃. Table 2 shows the results for the EP copolymers polymerized using the same catalysts.

TABLE 1
Solution polymerization, unsupported catalyst
for hPP (70 °C, MAO activation)

| | Activity | Mn | Mw | MWD | Tₘ |
|---|---|---|---|---|---|
| Catalyst | (kg/mmol · h) | (g/mol) | (g/mol) | (Mw/Mn) | (°C) |
| C₁ | 262.8 | 47,479 | 93,869 | 2.0 | 156.1 |
| C₁ | 373.3 | 45,134 | 83,682 | 1.9 | 153.3 |
| C₁ | 384.3 | 40,390 | 72,037 | 1.8 | 152.4 |
| C₂ | 264.1 | 46,906 | 80,572 | 1.7 | 146.8 |
| C₂ | 266.2 | 40,146 | 79,047 | 2.0 | 146.7 |
| C₂ | 288.7 | 43,793 | 83,847 | 1.9 | 146.5 |
| I₁ | 223.1 | 48,616 | 85,275 | 1.8 | 154.4 |
| I₁ | 235.7 | 48,629 | 80,467 | 1.7 | 153.2 |
| I₁ | 235.5 | 51,483 | 84,030 | 1.6 | 153.9 |
| I₂ | 273.0 | 40,607 | 69,458 | 1.7 | 152.9 |
| I₂ | 256.6 | 34,810 | 67,423 | 1.9 | 152.4 |
| I₂ | 264.9 | 43,180 | 76,111 | 1.8 | 152.4 |
| I₃ | 220.4 | 63,890 | 108,366 | 1.7 | 155.8 |
| I₃ | 193.2 | 57,103 | 101,938 | 1.8 | 154.4 |
| I₃ | 206.1 | 51,148 | 92,825 | 1.8 | 154.4 |

TABLE 2
Ethylene-propylene copolymerization, solution polymerization,
unsupported catalyst (70 °C, MAO activation)

| | Activity | Mn | Mw | MWD | Ethylene in |
|---|---|---|---|---|---|
| Catalyst | (kg/mmolh) | (g/mol) | (g/mol) | (Mw/Mn) | EP (wt %) |
| C₁ | 1398.5 | 36,435 | 103,609 | 2.8 | 20.0 |
| C₁ | 1576.2 | 36,849 | 93,864 | 2.5 | 23.8 |
| C₁ | 1488.7 | 40,353 | 107,463 | 2.7 | 20.3 |
| C₂ | 1032.7 | 45,120 | 108,359 | 2.4 | 19.8 |
| C₂ | 1215.2 | 39,293 | 106,346 | 2.7 | 19.8 |
| C₂ | 1098.5 | 47,014 | 104,315 | 2.2 | 21.2 |
| I₁ | 744.9 | 60,677 | 107,532 | 1.8 | 30.8 |
| I₁ | 882.4 | 47,098 | 96,613 | 2.1 | 31.4 |
| I₁ | 758.2 | 52,045 | 104,541 | 2.0 | 30.6 |
| I₂ | 1208.9 | 45,338 | 104,244 | 2.3 | 16.9 |
| I₂ | 1193.4 | 38,177 | 104,369 | 2.7 | 27.9 |
| I₂ | 1162.7 | 48,172 | 113,995 | 2.4 | 20.0 |
| I₃ | 751.3 | 67,496 | 133,038 | 2.0 | 31.6 |
| I₃ | 776.3 | 62,403 | 130,944 | 2.1 | 17.0 |
| I₃ | 737.6 | 70,752 | 144,677 | 2.0 | 24.2 |

The results in Tables 1 and 2 confirm that catalysts I₁-I₃ are highly active in polymerization of propylene, affording comparable polymer properties and equal or better polymer crystallinities relative to the comparative/control catalysts C₁ and C₂. In terms of EP copolymers, catalysts I₁ and 13 showed improvement in ethylene response, specifically higher incorporation at equal ethylene partial pressures relative to the control catalysts C₁, C₂.

### Example 2: Supported Catalysts

Catalysts C₁-C₂ and 11-13 were supported on conventional silica support and used to polymerize propylene under industrially relevant slurry and bulk slurry conditions.

### Preparation of Silica Supported MAO (SMAO)

In a celstir, 10.0 g of DM-L403 silica (AGC, dehydrated at 200 °C) was suspended in ca 100 mL of dry toluene and cooled to −30 °C. While stirring, 15.8 g of 30% cold solution of MAO was slowly added to the stirring silica mixture (over 10 minutes). The reactions were allowed to stir for 1.5 hours. After 1.5 hours, the temperature was raised to 100 °C and the reactions were allowed to stir for additional 2.5 hours. Upon cooling, the resulting slurry was filtered, and the solids were washed with toluene (2×50 mL), pentane (2×50 mL) and were dried in vacuo for at least 2 hours to give resulting SMAO as a white free flowing powder.

General Preparation of Supported Catalyst C₁, C₂, I₁, I₂ and I₃

In a 25 mL scintillation vial, 0.6 g of previous prepared SMAO was suspended in 10 mL of anhydrous toluene and placed on a shaker. 0.310 mL of triisobutylaluminum solution (1M in hexane) was then added and the resulting mixture was agitated for 15 minutes at room temperature. After 15 minutes, metallocene catalyst based on 12 μmol/g loading) was slowly added to the silica mixture as a toluene solution (about 2 mL). The resulting slurry was agitated for 3 hours. After 3 hours, the slurry was filtered on a glass frit, the solid was washed with toluene (2×5 mL) and pentane (2×5 mL) and dried in vacuo to give a supported catalyst as orange/red free flowing solids. Optionally, the resulting solids were suspended in mineral oil to make 5 wt % slurry which was used in lab reactor polymerizations.

### Bulk Polymerization Procedure

A 1 L autoclave reactor equipped with a mechanical stirrer was used for polymer preparation. Prior to the run, the reactor was placed under nitrogen purge while maintaining 90 °C temperature for 30 minutes. Upon cooling back to ambient temperature, propylene feed (500 mL), scavenger (0.2 mL of 1M TIBAL, triisobutylaluminum) and optionally hydrogen (charged from a 50 mL bomb at a desired pressure) were introduced to the reactor and were allowed to mix for 5 minutes. A desired amount of supported catalyst (typically 12.5-25.0 mg) was then introduced to the reactor by flushing the pre-determined amount of catalyst slurry (5 wt % in mineral oil) from a catalyst tube with 100 mL of liquid propylene. The reactor was kept for 5 minutes at room temperature (pre-poly stage), before raising the temperature to 70 °C. The reaction was allowed to proceed at that temperature for a desired time period (typically 30 minutes). After the given time, the temperature was reduced to 25 °C, the excess propylene was vented off and the polymer granules were collected, and dried under vacuum at 60 °C overnight.

### Slurry Polymerization Procedure

Slurry propylene polymerizations were carried out under high-throughput conditions according to the following general procedure. A pre-weighed glass vial insert and disposable stirring paddle were fitted to each reaction vessel of the reactor, which contains 48 individual reaction vessels. The reactor was then closed and propylene (typically 1-4 mL) was introduced. Triisobutyl aluminum (TIBAL) is then introduced as a scavenger (typically 2.5-10 μmol) added as either toluene or isohexane solution. Then solvent (typically the isohexane) was added to bring the total reaction volume, including the subsequent additions, to 5 mL and the reactor vessels were heated to their set temperature (usually from about 50 °C to about 110 °C). At this stage ethylene (typically 70-140 psi) was added to the reactor. The contents of the vessel were stirred at 800 rpm. Supported catalyst (typically 0.75 mg) was introduced as toluene slurry (typically at 3.0 mg/mL concentration) to initiate the reaction. Equivalence is determined based on the mol equivalents relative to the moles of the transition metal in the catalyst complex. The reaction was then allowed to proceed until a pre-determined amount of pressure had been taken up by the reaction or in the case of homopolymerizations it was allowed to proceed for 30 minutes. At this point, the reaction was quenched by pressurizing the vessel with either compressed air or carbon dioxide. After the polymerization reaction, the glass vial insert containing the polymer product and solvent was removed from the pressure cell and the inert atmosphere glove box, and the volatile components were removed using a Genevac HT-12 centrifuge and Genevac VC3000D vacuum evaporator operating at elevated temperature and reduced pressure. The vial was then weighed to determine the yield of the polymer product. The resultant polymer was analyzed by Rapid GPO (see below) to determine the molecular weight and by DSC (see below) to determine melting point.

TABLE 3
Results for slurry polymerization with supported catalysts.

| | | | | | | Ethylene | |
|---|---|---|---|---|---|---|---|
| | Activity | Propylene | Ethylene | Mn | Mw | in EP | Tm |
| Catalyst | (g/g · h) | (psi) | (psi) | (g/mol) | (g/mol) | (wt %) | (°C) |
| C₁ | 503.2 | 380 | 0 | 233,187 | 513,058 | — | 156.1 |
| C₁ | 554.1 | 380 | 0 | 230,237 | 526,128 | — | 155.1 |
| C₁ | 14523.2 | 180 | 70 | 66,604 | 116,620 | 30.8 | — |
| C₁ | 8554.3 | 180 | 70 | 100,388 | 179,535 | 33.6 | — |
| C₁ | 15646.8 | 110 | 140 | 87,592 | 148,048 | 52.8 | — |
| C₁ | 11574.2 | 110 | 140 | 114,655 | 197,849 | 39.2 | — |
| C₂ | 433.3 | 380 | 0 | 244,999 | 485,570 | — | 152.5 |
| C₂ | 610.9 | 380 | 0 | 216,915 | 473,658 | — | 150.8 |
| C₂ | 7191.4 | 180 | 70 | 71,186 | 122,027 | 33 | — |
| C₂ | 10282.1 | 180 | 70 | 65,955 | 107,032 | 26.2 | — |
| C₂ | 16126.8 | 110 | 140 | 69,547 | 122,397 | 52.3 | — |
| C₂ | 19916.1 | 110 | 140 | 63,544 | 114,255 | 51.9 | — |
| I₁ | 115.4 | 380 | 0 | 143,507 | 396,652 | — | 157.6 |
| I₁ | 151.9 | 380 | 0 | 200,272 | 453,115 | — | 156.1 |
| I₁ | 1581.3 | 180 | 70 | 86,779 | 171,621 | 31.6 | — |
| I₁ | 4354.1 | 180 | 70 | 77,269 | 133,633 | 26.7 | — |
| I₁ | 6189.7 | 110 | 140 | 75,643 | 138,254 | 51.6 | — |
| I₁ | 7089.6 | 110 | 140 | 77,409 | 134,001 | 52.8 | — |
| I₂ | 253.6 | 380 | 0 | 159,248 | 462,694 | — | 156.7 |
| I₂ | 160.8 | 380 | 0 | 214,348 | 492,075 | — | 155.4 |
| I₂ | 4299.3 | 180 | 70 | 137,134 | 235,521 | 28.2 | — |
| I₂ | 6531.4 | 180 | 70 | 99,086 | 172,206 | 22.8 | — |
| I₂ | 6966.8 | 110 | 140 | 118,678 | 213,603 | 51.8 | — |
| I₂ | 7578.2 | 110 | 140 | 125,725 | 218,863 | 52.2 | — |
| I₃ | 204.2 | 380 | 0 | 216,047 | 530,872 | — | 155.7 |
| I₃ | 198.9 | 380 | 0 | 240,475 | 581,320 | — | 154.1 |
| I₃ | 720.6 | 180 | 70 | 154,799 | 263,290 | 31.8 | — |
| I₃ | 2800.9 | 180 | 70 | 122,597 | 209,753 | 30.6 | — |
| I₃ | 5750.0 | 110 | 140 | 137,202 | 231,518 | 52.4 | — |
| I₃ | 5389.4 | 110 | 140 | 135,551 | 236,701 | 51.4 | — |

TABLE 4
Results for bulk-slurry polymerization of propylene
with supported catalyst (70 °C, with 2 mmol H₂)

| | | Catalyst | | | | | | |
|---|---|---|---|---|---|---|---|---|
| Reactor | | amount | Polymer | Productivity | Mn | Mw | MWD | Tm |
| run | Catalyst | (mg) | yield (g) | (g/g · h) | (g/mol) | (g/mol) | (Mw/Mn) | (°C) |
| 1 | C₁ | 12.6 | 83.0 | 13,215 | 50,497 | 158,925 | 3.15 | 158.0 |
| 2 | I₁ | 12.4 | 50.3 | 8,112 | 56,951 | 159,716 | 2.80 | 159.0 |
| 3 | I₂ | 12.6 | 112.7 | 17,935 | 65,131 | 185,557 | 2.85 | 158.5 |
| 4 | I₃ | 12.7 | 64.4 | 10,173 | 44,464 | 142,150 | 3.20 | 157.8 |

The data in Table 3 confirms excellent activity and operability of the inventive arylsilane substituted catalysts I₁-I₃. Significant improvement of EP rubber molecular weight capability was also demonstrated, especially with catalysts I₂ and I₃. In terms of homopolypropylene polymerization with catalyst I₂, significant improvement in activity (ca 18,000 g/g) was observed relative to control catalyst C₁ (13,200 g/g) under bulk slurry conditions (Table 4). The polymers produced with silafluorenyl bridged system I₁ showed a slight improvement in melting point (Tm=159 °C relative to control C₁).

It was nothing short of surprising and unexpected that the silane bridged metallocenes I₁, I₂ and I₃ showed excellent activity for making hPP and EP copolymers. It was also nothing short of surprising and unexpected that the silane bridged metallocenes I₁, I₂ and I₃ were able to produce higher melting point hPPs (>153 °C) and ethylene-propylene copolymers with higher molecular weights (Mw), which allows for improved impact properties.

### Test Procedures Used:

Rapid GPC procedure: To determine various molecular weight related values by GPC, high temperature size 5 exclusion chromatography was performed using an automated “Rapid GPC” system as generally described in U.S. Pat. Nos. 6,491,816; 6,491,823; 6,475,391; 6,461,515; 6,436,292; 6,406,632; 6,175,409; 6,454,947; 6,260,407; and 6,294,388, each of which is fully incorporated herein by reference for US purposes. This apparatus was a series of three 30 cm×7.5 mm linear columns, each containing PLgel 10 μm, Mix B. The GPC system was calibrated using polystyrene standards ranging from 580-3,390,000 g/mol. The system was operated at an eluent flow rate of 2.0 mL/minutes and an oven temperature of 165 °C 1,2,4-trichlorobenzene was used as the eluent. The polymer samples were dissolved in 1,2,4-trichlorobenzene at a concentration of 0.1-0.9 mg/mL. 250 uL of a polymer solution was injected into the system. The concentration of the polymer in the eluent was monitored using an evaporative light scattering detector (as shown by the examples in Table 3) or Polymer Char IR4 detector. The molecular weights presented are relative to linear polystyrene standards and are uncorrected.

DSC Procedure, DSC-1: For the high throughput samples, the melting temperature (Tm) was measured using Differential Scanning Calorimetry (DSC) using commercially available equipment such as a TA Instruments TA-Q200 DSC. Typically, 5 to 10 mg of molded polymer or plasticized polymer was sealed in an aluminum pan and loaded into the instrument at about room temperature. Samples were pre-annealed at about 220 °C for about 15 minutes and then allowed to cool to about room temperature overnight. The samples were then heated to about 220 °C at a heating rate of about 100 °C/minute, held at this temperature for at least about 5 minutes, and then cooled at a rate of about 50 °C/minute to a temperature typically at least about 50 °C below the crystallization temperature. Melting points were collected during the heating period.

DSC Procedure, DSC-2: Peak melting point, Tm, described for reactor batches (also referred to as melting point) and peak crystallization temperature, Tc, (also referred to as crystallization temperature) are determined using the following DSC procedure according to ASTM D3418-03. Differential scanning calorimetric (DSC-2) data can be obtained using a TA Instruments model DSC2500 machine. Samples weighing approximately 5 to 10 mg are sealed in an aluminum hermetic sample pan and loaded into the instrument at about room temperature. The DSC data are recorded by first gradually heating the sample to about 200 °C at a rate of about 10 °C/minute. The sample is kept at about 200 °C for 5 minutes, then cooled to about −50 °C at a rate of about 10 °C/minute, followed by an isothermal for about 5 minutes and heating to about 200 °C at about 10 °C/minute, holding at about 200 °C for about 5 minutes and then cooling down to about 25 °C at a rate of about 10 °C/minute. Both the first and second cycle thermal events were recorded. The melting and crystallization temperatures reported here were obtained during the second heating/cooling cycle unless otherwise noted. In the event of conflict between the DSC Procedure-1 and DSC procedure-2, DSC procedure-2 is used.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention can be devised without departing from the basic scope thereof, and the scope thereof is determined by the claims that follow.

1. A catalyst system comprising a metallocene compound described in the Formula (I): 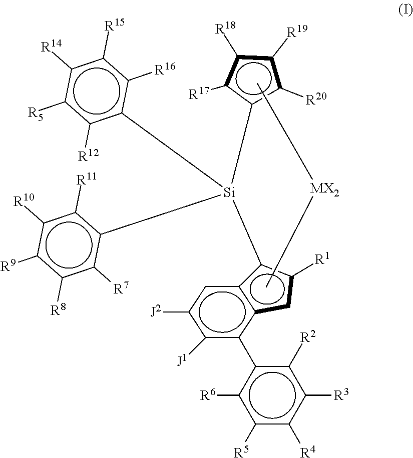
where:
M is a Group 4 metal;
each of X1 and X2 is a univalent anionic ligand, or X1 and X2 are joined to form a metallocycle ring; R¹ is hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, where R″ is C₁-C₁₀ alkyl and each R′ is hydrogen, halogen, C₁-C₁₀ alkyl, or C₆-C₁₀ aryl;
J¹ and J² are independently hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, where R″ is C₁-C₁₀ alkyl and each R′ is hydrogen, halogen, C₁-C₁₀ alkyl, or C₆-C₁₀ aryl. Optionally J¹ and J² can be joined to form a 4, 5 or 6 membered ring;
each R²-R⁶ is hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, where R″ is C₁-C₁₀ alkyl and each R′ is hydrogen, halogen, C₁-C₁₀ alkyl, or C₆-C₁₀ aryl;
each R⁷-R¹⁶ is hydrogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, where R″ is C₁-C₁₀ alkyl and each R′ is hydrogen, halogen, C₁-C₁₀ alkyl, or C₆-C₁₀ aryl; optionally, R″ and R¹² can be joined to form a silafluorene moiety; and
each R¹⁷, R¹⁸, R¹⁹, and R²⁰ is independently hydrogen, a halogen, an unsubstituted C₁-C₄₀ hydrocarbyl, a C₁-C₄₀ substituted hydrocarbyl, an unsubstituted C₄-C₆₂ aryl, a substituted C₄-C₆₂ aryl, an unsubstituted C₄-C₆₂ heteroaryl, a substituted C₄-C₆₂ heteroaryl, —NR′², —SR′, —OR, —SiR′³, —OSiR′³, —PR′², or —R″—SiR′³, wherein R″ is C₁-C₁₀ alkyl and each R′ is hydrogen, halogen, C₁-C₁₀ alkyl, or C₆-C₁₀ aryl.

2. The catalyst system of claim 1, further comprising an activator.

3. The catalyst system of claim 2, wherein the activator is either aluminoxane or salts of non-coordinating (NCA) anions.

4. The catalyst system of claim 3, wherein the activator is a NCA represented by the formula: (Z)d⁺ (Ad⁻)
wherein Z is (L-H) or a reducible Lewis Acid,
L is a Lewis base;
H is hydrogen;
(L−H)+ is a Bronsted acid;
Ad− is a non-coordinating anion having the charge d−; and
d is an integer from 1 to 3.

5. The catalyst system of claim 3, wherein the activator is a NCA represented by the formula: (Z)d+(Ad−) wherein Ad− is a non-coordinating anion having the charge d−; d is an integer from 1 to 3, and Z is a reducible Lewis acid represented by the formula: (Ar3C+), where Ar is aryl or aryl substituted with a heteroatom, a C₁ to C₄₀ hydrocarbyl, or a substituted C₁ to C₄₀ hydrocarbyl.

6. The catalyst system of claim 2, wherein the activator is aluminoxane and a ratio of the aluminoxane to metal is at least 1:100, or at least 1:250, or at least 1:500.

7. The catalyst system of claim 1, further comprising a support material.

8. The catalyst system of claim 7, wherein the support material is selected from Al₂O₃, ZrO₂, SiO₂, SiO₂/Al₂O₃, SiO₂/TiO₂, silica clay, silicon oxide/clay, and mixtures thereof.

9. A process for preparing a propylene homopolymer or copolymer, comprising:
introducing propylene, one or more C₂ or C₄ to C₄₀ olefin comonomers, and a catalyst system of claim 1, and optionally hydrogen into a reactor at a reactor pressure of from 0.7 bar to 70 bar and a reactor temperature of from 20 °C to 150 °C; and
obtaining a propylene homopolymer or copolymer.

10. The process of claim 9, wherein the C₄ to C₄₀ olefin comonomers are selected from the group consisting of 1-butene, 1-pentene, 1-hexene, 2-methyl-1-pentene, vinylcyclobutane, 1-heptene, 1-octene, 1-decene, 1,5-hexadiene, 1,7-octadiene and 1,9-decadiene.

11. The process of claim 9, wherein the propylene homopolymer or copolymer has a Mw value of 5,000 to 500,000 g/mol, or from 5,000 to 350,000 or from 10,000 to 250,000 as measured by gel permeation chromatography.

12. The process of claim 9, wherein the propylene homopolymer or copolymer has a Mw value of 10,000 to 250,000 as measured by gel permeation chromatography.

13. The process of claim 9, wherein the propylene homopolymer or copolymer has a melt-flow rate (MFR) according to ASTM D1238 (230 °C, 2.16 kg) of 0.1 dg/minute to 3000 dg/minute, or from 1 dg/minute to 1000 dg/minute, or from 10 dg/minute to 100 dg/minute, or from 20 dg/minute to 70 dg/minute.

14. The process of claim 11, wherein the propylene homopolymer or copolymer has a molecular weight distribution (Mw/Mn) of about 2 to about 30, or about 3 to about 20, or about 4 to about 10.

15. The process of claim 9, wherein the propylene homopolymer or copolymer has a melting temperature (Tm) of greater than 80 °C, or greater than 130 °C, or greater than 150 °C.

16. The process of claim 11, wherein the propylene co-polymer has a comonomer content of 0.1-50 wt %.

17. The process of claim 1, wherein the propylene co-polymer has a comonomer content of 1 to 35 wt %, or from 2 to 20 wt %, or from 3 to 10 wt %.
